(19) United States
(12) Patent Application Publication
(10) Pub. No.: US 2008/0046349 A1
(43) Pub. Date: Feb. 21, 2008

(54) Method and systems for providing online banking and account aggregation services

(75) Inventors: Edwin Elberg, Woburn, MA (US); Raul Aldrey, Dallas, TX (US); Diego Crespo, Boston, MA (US); Luis Blando, Woburn, MA (US); Anil Guntupalli, Waltham, MA (US); Sudhanshu Sharma, Malden, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Data Services Inc., Temple Terrace, FL (US)

(21) Appl. No.: 11/505,350

(22) Filed: Aug. 17, 2006

(51) Int. Cl. G06Q 40/00

(52) U.S. Cl. 705/35

(57) ABSTRACT

Methods and apparatuses for providing aggregated financial services at a plurality of user access points, such as a cellular phone or a television, are provided. Each user access point is capable of communicating with an integrated communications network, through which the aggregated financial services are provided. The aggregated financial services are directed to enabling the user to centrally manage a variety of dispersed financial accounts, including the user's bank accounts, brokerage accounts, credit card accounts, frequent flyer accounts, reward programs, and any other accounts that may impact the user's financial position. Using the aggregated financial services, the user may perform a variety of transactions in and among one or more of the financial accounts without having to separately interacting with each of these accounts.

### BACKGROUND

Recent technology advancements have made online financial services cheaper to provide and easier to use. As the variety and popularity of these services grew, the challenge became how to provide easy access and management of the services so as to generate a clear picture of the user's overall financial situation.

Today, it is not unusual for a single user to maintain accounts at multiple financial intuitions or online financial services. These services may include banking services, brokerage services, credit card services, various reward programs, and an array of other services. Generally, each of these accounts requires separate access and management. This means, when using a particular service, a user must first log on to the specific service site, and then perform transactions subject to the specific rules and limitations of that site. Thus, the user is forced to manually track and consolidate information from multiple dispersed financial accounts in order to piece together his overall financial position.

Additionally, many online financial services are only accessible through a web-enabled personal computer, even though the user has a wide variety of other user access points at his disposal. These user access points may include portals implemented on interactive televisions, PDAs, pagers, phones, etc. No comprehensive system currently exists that effectively deploys online financial services across these wide variety of user access points in a synchronized and integrated fashion.

Thus, there is a need for an improved method and system for providing aggregated financial services at a wide variety of user access points, so that the user's various financial accounts may be integrated and easily accessed. There is also a need for a method and system for converging data services for providing such aggregated financial services with telephony services and/or television services in one unit so as to allow the user to have one central location where they can perform call management functions as well as managing his or her consolidated financial accounts.

### SUMMARY

Consistent with embodiments of the present invention, systems and methods are disclosed for providing aggregated financial services at a variety of user access points through an integrated platform.

In one aspect of the present invention, a plurality of user access points, including a website, a television portal, a desktop client, a voice portal, a PDA portal, a PPA portal (e.g., Microsoft's Outlook™ or IBM's Lotus program), or any other suitable portal may be provided at, for example, a PDA, a HDTV/PVR, a cell phone, an integrated phone such as Verizon One, a PC, or any other suitable device capable of connecting to an integrated communications network. A user may use one or more of these user access points to gain access to aggregated financial services. The aggregated financial services are directed to enabling the user to centrally manage a variety of dispersed financial accounts, including the user's bank accounts, brokerage accounts, credit card accounts, frequent flyer accounts, reward programs, and any other accounts that may impact the user's financial position. Using the aggregated financial services, the user may perform a variety of transactions in and among one or more of the financial accounts without separately interacting with each of these accounts.

In another aspect of the present invention, aggregated financial services include alerting or notifying the user of account activities, transactions, or any other suitable account-related events at one or more of the user's user access points. The notification may be specific to each type of service, including bill payments, fund transfers, overdrafts, account activities, mileages, etc. For each type of service, the alert or notification may be specific as to the type of events, including, for example, cleared checks, warning of overdrafts, completed transfers, and any other suitable events. In some embodiments of the present invention, the user may be alerted to or reminded of future events such as unpaid bills, scheduled transfers, and any other suitable future events. The alerts or notifications may be generated automatically based on, for example, default notification criteria, or may be customized and requested by the user.

Both the foregoing general description and the following detailed description are exemplary and are intended to provide further explanation of the invention as claimed.

### BRIEF DESCRIPTION OF THE DRAWINGS

FIG. 1 is a diagram of an exemplary data processing and telecommunications environment, consistent with the principles of the present invention;

FIG. 2 is a diagram of an exemplary user terminal, consistent with the principles of the present invention;

FIG. 3 is a diagram of a voice network, consistent with the principles of the present invention;

FIG. 4 is a block diagram of a service center, consistent with the principles of the present invention;

FIG. 5 illustrates a logical architecture of an exemplary system, consistent with the principles of the present invention;

FIG. 6 shows an illustrative concierge services screen, consistent with one embodiment of present invention;

FIG. 7 shows an illustrative consolidated bank account screen, consistent with one embodiment of the present invention;

FIG. 8 shows an illustrative bank account detail screen, consistent with one embodiment of the present invention;

FIG. 9 shows an illustrative consolidated financial summary screen, consistent with one embodiment of the present invention;

FIG. 10 shows an illustrative consolidated outstanding bill screen, consistent with one embodiment of the present invention;

FIG. 11 shows an illustrative calendar screen displaying outstanding bills, consistent with one embodiment of the present invention;

FIG. 12 is a flow chart of illustrative steps involved in providing consolidated financial information at a variety of user access points, consistent with one embodiment of the present invention;

FIG. 13 shows an illustrative notification schedule setup screen, consistent with one embodiment of the present invention;

FIG. 14 is a flow chart of illustrative steps involved in providing a financial transaction-related notification to a preferred user access point, consistent with one embodiment of the present invention;

FIG. 15 is a block diagram of a television-related system, consistent with the principles of the present invention;

FIG. 16 is a detailed block diagram of a service provider, consistent with the principles of the present invention.

FIG. 17 is a detailed block diagram of a subscriber, consistent with the principles of the present invention; and

FIG. 18 is a detailed block diagram of set top box, consistent with the principles of the present invention.

### DETAILED DESCRIPTION OF PREFERRED EMBODIMENTS

Reference will now be made in detail to exemplary embodiments of the present invention, examples of which are illustrated in the accompanying drawings. Wherever possible, the same reference numbers will be used throughout the drawings to refer to the same or like parts. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Data/Voice Network Overview

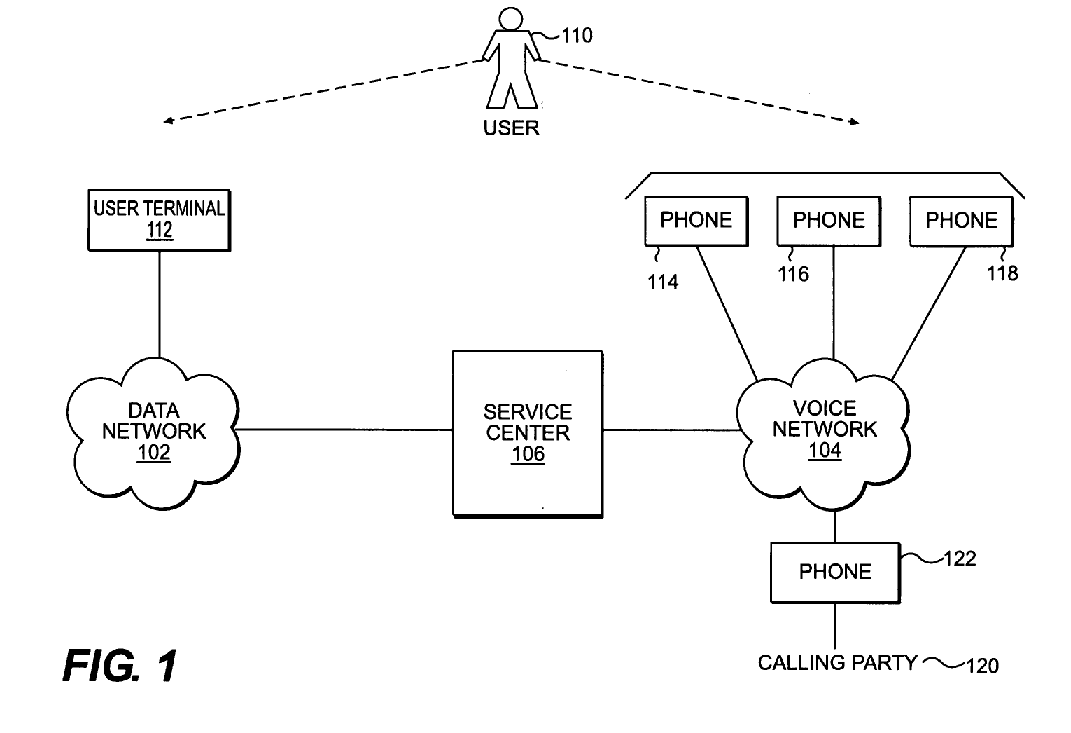

FIG. 1 is a block diagram of a data processing and telecommunications environment 100, in which features and aspects consistent with the present invention may be implemented. The number of components in environment 100 is not limited to what is shown and other variations in the number of arrangements of components are possible, consistent with embodiments of the invention. The components of FIG. 1 may be implemented through hardware, software, and/or firmware. Data processing and telecommunications environment 100 may include a data network 102, a voice network 104, and a service center 106. A user 110 may use a user terminal 112 to interface with data network 102 and may use phones 114, 116, and 118 to interface with voice network 104. Calling party 120 may use phone 122 to call a user, such as user 110, at any one of phones 114, 116, and 118.

Data network 102 provides communications between the various entities depicted in environment 100 of FIG. 1, such as user terminal 112 and service center 106. Data network 102 may be a shared, public, or private network and encompass a wide area or local area. Data network 102 may be implemented through any suitable combination of wired and/or wireless communication networks. By way of example, data network 102 may be implemented through a wide area network (WAN), local area network (LAN), an intranet and/or the Internet. Further, the service center 106 may be connected to multiple data networks 102, such as, for example, to a wireless carrier network and to the Internet.

Voice network 104 may provide telephony services to allow a calling party, such as calling party 120, to place a telephone call to user 110. In one embodiment, voice network 104 may be implemented using a network, such as the Public Switched Telephone Network (“PSTN”). Alternatively, voice network 104 may be implemented on a voice over broadband network, such as a network using voice-over Internet Protocol (“VoIP”) technology. Additionally, in other embodiments, the voice network may be a video over broadband network, such as, for example, a network for providing 2-way video communications. In another example, the voice network may be a wireless broadband network, such as, for example, a network using WiFi (i.e., IEEE 802.11(b) and/or (g)). In yet another example, the voice network 104 may be a wireless voice network(s), such as, for example, a cellular or third-generation cellular network. In addition, voice network 104 may be implemented using any single or combination of the above-described technologies consistent with the principles of the present invention. Further, service center 106 may be connected to multiple voice networks 104, such as for example, Verizon's™ Voice Network, voice networks operated by other carriers, and wireless carrier networks.

Service center 106 provides a platform for managing communications over data network 102 and voice network 104. Service center 106 also provides gateway functions, such as code and protocol conversions, to transfer communications between data network 102 and voice network 104. Service center 106 may be implemented using a combination of hardware, software, and/or firmware. For example, service center 106 may be implemented using a plurality of general purpose computers or servers coupled by a network (not shown). Although service center 106 is shown with direct connections to data network 102 and voice network 104, any number and type of network elements may be interposed between service center 106, data network 102, and voice network 104.

User terminal 112 provides user 110 an interface to data network 102. For example, user terminal 112 may be implemented using any device capable of accessing the Internet, such as a general purpose computer or personal computer equipped with a modem. User terminal 112 may also be implemented in other devices, such as the Blackberry™, and Ergo Audrey™. Furthermore, user terminal 112 may be implemented in wireless devices, such as pagers, mobile phones (with data access functions), and Personal Digital Assistants (“PDA”) with network connections. In one embodiment, a user terminal 112 may be implemented using a device with connections to both data network 102 and voice network 104. User terminal 112 also allows user 110 to communicate with service center 106. For example, user 110 may use instant messaging (“IM”) to communicate with service center 106. In addition, user terminal 112 may use other aspects of TCP/IP including the hypertext transfer protocol (“HTTP”); the user datagram protocol (“UDP”); the file transfer protocol (“FTP”); the hypertext markup language (“HTML”); and the extensible markup language (“XML”).

Furthermore, user terminal 112 may communicate directly with service center 106. For example, a client application may be installed on user terminal 112, which directly communicates with service center 106. Also, user terminal 112 may communicate with service center 106 via a proxy.

Phones 114, 116, 118, and 122 interface with voice network 104. Phones 114, 116, 118, and 122 may be implemented using known devices, including wireline phones and mobile phones. Although phones 114, 116, 118, and 122 are shown directly connected to voice network 104, any number of intervening elements, such as a private branch exchange (“PBX”), may be interposed between phones 114, 116, 118, and 122 and voice network 104.

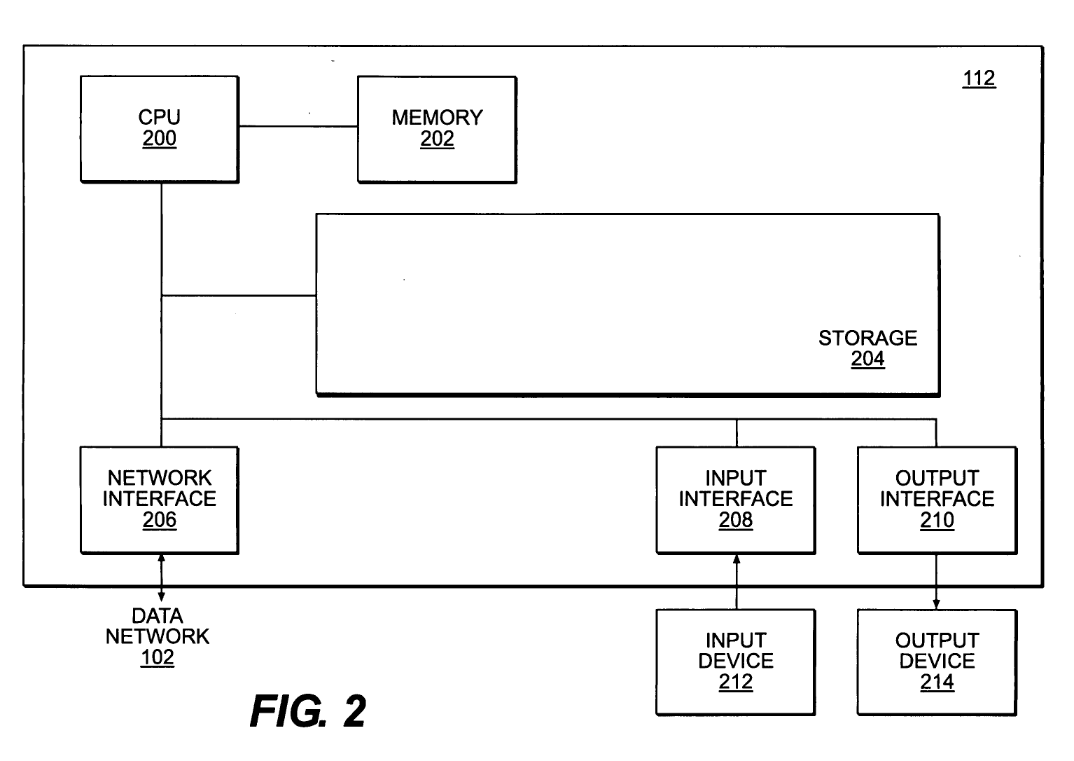

FIG. 2 is a block diagram of a user terminal consistent with the present invention. User terminal 112 may include a central processing unit (CPU) 200, a memory 202, a storage module 204, a network interface 206, an input interface 208, an output interface 210, an input device 212, and an output device 214.

CPU 200 provides control and processing functions for user terminal 112. Although FIG. 2 illustrates a single CPU, user terminal 112 may include multiple CPUs. CPU 200 may also include, for example, one or more of the following: a co-processor, memory, registers, and other processing devices and systems as appropriate. CPU 200 may be implemented, for example, using a Pentium™ processor provided from Intel Corporation.

Memory 202 provides a primary memory for CPU 200, such as for program code. Memory 202 may be embodied with a variety of components of subsystems, including a random access memory (“RAM”) and a read-only memory (“ROM”). When user terminal 112 executes an application installed in storage module 204, CPU 200 may download at least a portion of the program code from storage module 204 into memory 202. As CPU 200 executes the program code, CPU 200 may also retrieve additional portions of program code from storage module 204.

Storage module 204 may provide mass storage for user terminal 112. Storage module 204 may be implemented with a variety of components or subsystems including, for example, a hard drive, an optical drive, CD ROM drive, DVD drive, a general-purpose storage device, a removable storage device, and/or other devices capable of storing information. Further, although storage module 204 is shown within user terminal 112, storage module 204 may be implemented external to user terminal 112.

Storage module 204 includes program code and information for user terminal 112 to communicate with service center 106. Storage module 204 may include, for example, program code for a calendar application, such as GroupWise™ provided by Novell Corporation or Outlook™ provided by Microsoft Corporation; a client application, such as a Microsoft Network Messenger Service (MSNMS) client or America Online Instant Messenger (AIM) client; and an Operating System (OS), such as the Windows Operation System provided by Microsoft Corporation. In addition, storage module 204 may include other program code and information, such as program code for TCP/IP communications; kernel and device drivers; configuration information, such as a Dynamic Host Configuration Protocol (DHCP) configuration; a web browser, such as Internet Explorer™ provided by Microsoft Corporation, or Netscape Communicator™ provided by Netscape Corporation; and any other software that may be installed on user terminal 112.

Network interface 206 provides a communications interface between user terminal 112 and data network 102. Network interface 206 may receive and transmit communications for user terminal 112. For example, network interface 206 may be a modem, or a local area network (“LAN”) port.

Input interface 208 receives input from user 110 via input device 212 and provides the input to CPU 200. Input device 212 may include, for example, a keyboard, a microphone, graphical user interface, and/or a mouse. Other types of input devices may also be implemented consistent with the principles of the present invention.

Output interface 210 provides information to user 110 via output device 214. Output device 214 may include, for example, a display, (including a touchscreen or pen-based LCD display, or other type of display), a printer, and/or a speaker. Other types of output devices may also be implemented consistent with the principles of the present invention.

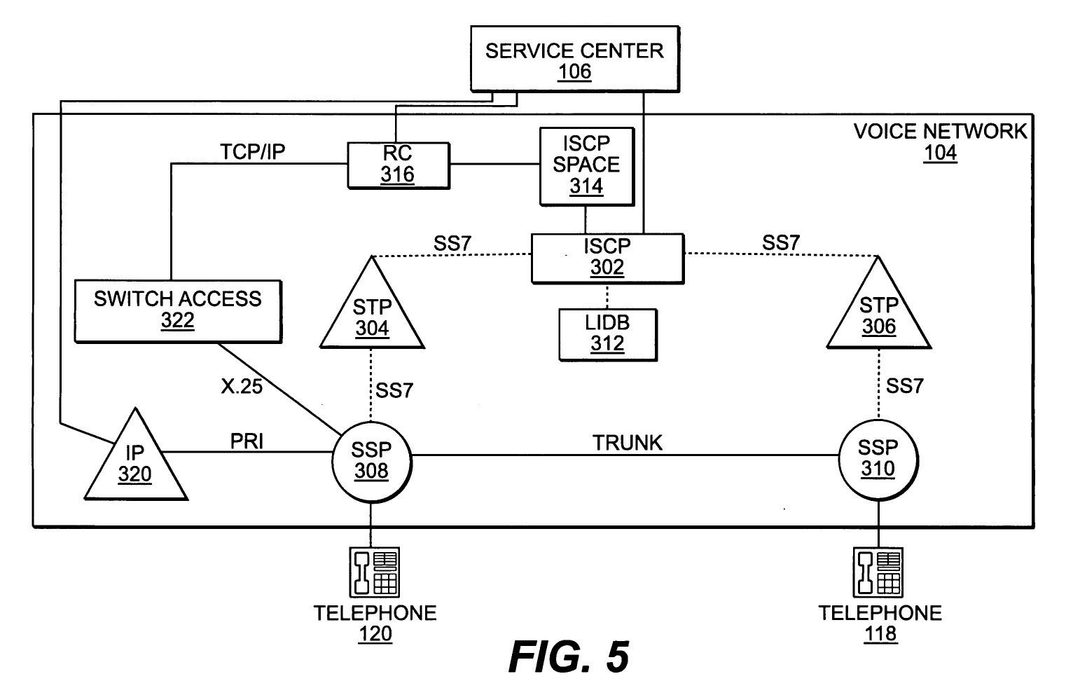

FIG. 5 is a diagram of a voice network, consistent with the principles of the present invention. As shown, voice network 104 includes an intelligent service control point (ISCP) 302, service transfer points (STP) 304 and 306, service switching points (SSP) 308 and 310, a line information database (LIDB) 312, an ISCP Service Provisioning And Creation Environment (SPACE) 314, a Recent Change Environment 316, an Intelligent Peripheral (IP) 320, and a switch access 322. Although this embodiment of a voice network 104 is described as a PSTN, as discussed above in other embodiments, the voice network 104 may be, for example, a voice or video over broadband network, a wireless broadband, a wireless voice network, etc.

Voice network 104 may be implemented using the PSTN and SS7 as a signaling protocol. The SS7 protocol allows voice network 104 to provide features, such as call forwarding, caller-ID, three-way calling, wireless services such as roaming and mobile subscriber authentication, local number portability, and toll-free/toll services. The SS7 protocol provides various types of messages to support the features of voice network 104. For example, these SS7 messages may include Transaction Capabilities Applications Part (“TCAP”) messages to support event “triggers,” and queries and responses between ISCP 302 and SSPs 308 and 310.

ISCP 302 may also be, for example, a standard service control point (SCP), an Advanced Intelligent Network (AIN) SCP, a soft switch, or any other network call controller. ISCP 302 provides translation and routing services of SS7 messages to support the features of voice network 104, such as call forwarding. In addition, ISCP 302 may exchange information with the service center 106 using TCP/IP or SS7. ISCP 302 may include service logic used to provide a switch, such as SSP 308 or 310, with specific call processing instructions. ISCP 302 may also store data related to various features that a user may activate. Such features may include, for example, call intercept and voice mail. ISCP 302 may be implemented using a combination of known hardware and software. ISCP 302 is shown with a direct connection to service center 106 and a connection to ISCP SPACE 314, however, any number of network elements including routers, switches, hubs, etc., may be used to connect ISCP 302, ISCP SPACE 314, and service center 106. Further, information exchanged between the ISCP 302 and service center 106 may use, for example, the SR-3389 General Data Interface (GDI) for TCP/IP.

STPs 304 and 306 relay SS7 messages within voice network 104. For example, STP 304 may route SS7 messages between SSPs 308 and 310. STP 304 or 306 may be implemented using known hardware and software from manufacturers such as NORTEL™ and LUCENT Technologies™.

SSPs 308 and 310 provide an interface between voice network 104 and phones 114 and 120, respectively, to setup, manage, and release telephone calls within voice network 104. SSPs 308 and 310 may be implemented as a voice switch, an SS7 switch, or a computer connected to a switch. SSPs 308 and 310 exchange SS7 signal units to support a telephone call between calling party 120 and user 110. For example, SSPs 308 and 310 may exchange SS7 messages, such as TCAP messages, within message signal units (“MSU”) to control calls, perform database queries to configuration database 312, and provide maintenance information.

Line Information Database (LIDB) 312 comprises one or more known databases to support the features of voice network 104. For example, LIDB 312 may include subscriber information, such as a service profile, name and address, and credit card validation information. Although, in this figure, LIDB 312 is illustrated as directly connected to ISCP 302, LIDB 312 may be connected to ISCP 302 through an STP (e.g., 304 and 306). Additionally, this communication link may use, for example, the GR-2838 General Dynamic Interface (GDI) for SS7.

ISCP Service Provisioning and Creation Environment (SPACE) 314 may be included as part of the ISCP 302 or be separate from the ISCP 302. For example, the Telcordia™ ISCP may include an environment similar to SPACE 314 as part of the product. Further, ISCP SPACE 314 may include one or more servers. ISCP SPACE 314 is the point in the ISCP platform where customer record updates may be made.

In one embodiment, customer records may be stored in the ISCP SPACE 314 such that the records may be updated and sent to the ISCP 302. These records may include information regarding how to handle calls directed to the customer. For example, these customer records may include information regarding whether or not calls for the customer are to be forwarded to a different number, and/or whether or not the call should be directed to an IP, such as a voice mail system, after a certain number of rings. Additionally, one ISCP SPACE 314 may provide updates to one or more ISCPs 302 via an ISCP network (not shown).

Additionally, the voice network 104 may include one or more recent change engines 316 such as, for example, an Enterprise Recent Change engine (eRC); an Assignment, Activation, and Inventory System (AAIS); or a multi-services platform (MSP). As an example, the eRC and AAIS may be used in voice networks 104 located in the western part of the United States, while an MSP may be used in networks in the eastern part. The recent change engines may be used to update switch and ISCP databases. For example, a recent change engine may deliver database updates to SSPs and to ISCPs, such that when updating databases, these recent change engines emulate human operators. Additionally, if the instructions are to be sent to an ISCP 302, the recent change engine may first send the instructions to the ISCP SPACE 314, which then propagates the instructions to the ISCP 302 as discussed above. Further, an MSP or eRC may be used, for example, for providing updates to both the SSPs 308 or 310 and the ISCPs 302. Or, for example, an eRC may be used for providing updates to the SSPs 308 or 310, while an AAIS is used for providing updates to the ISCPs 302.

Updates sent to the SSPs 308 or 310 may be sent from the recent change engine 316 via a switch access 322 that may, for example, convert the updates into the appropriate protocol for the SSP 308 or 310. For example, recent change engine 316 may send updates to the SSPs 308 or 310 via TCP/IP. The switch access 322 may then convert the updates from TCP/IP to X.25. This switch access 322 may be implemented using hardware and/or software. These connections may include any number of elements, such as, for example, switches, routers, hubs, etc. and may be, for example, an internal data network for the voice network 104.

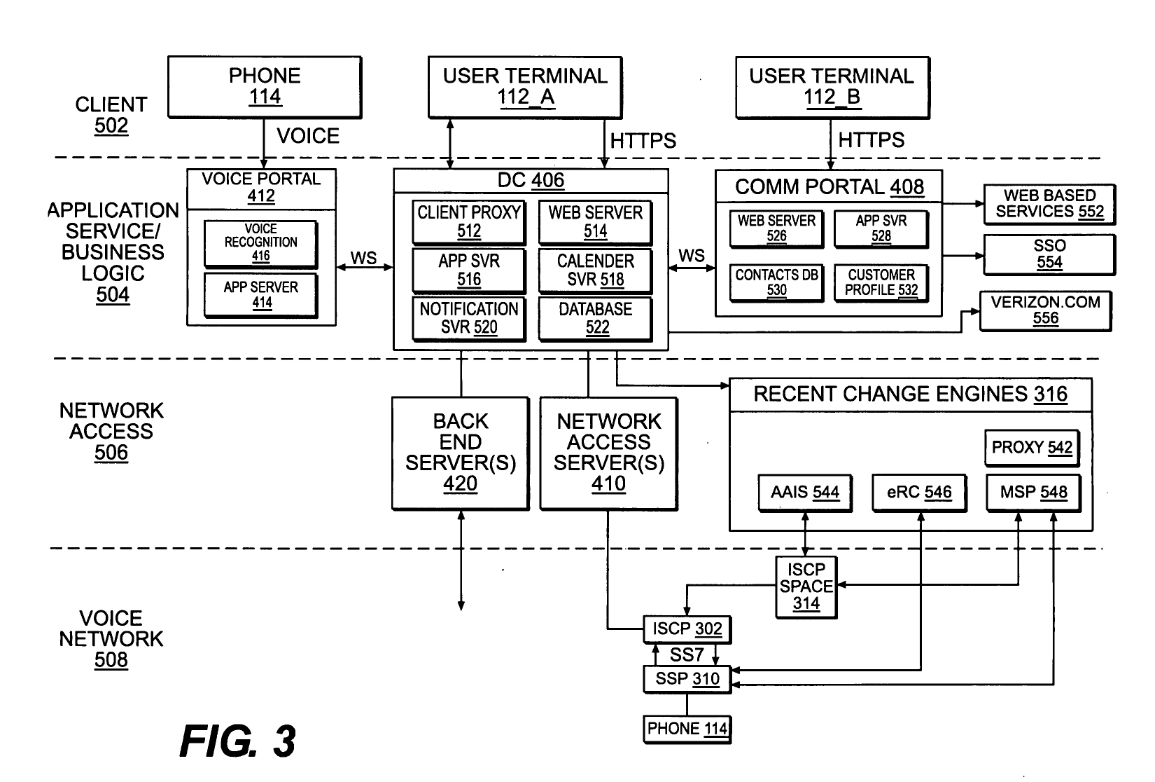

The voice network 104 may also include one or more intelligent peripherals (IP). For example, in FIG. 3, an IP 302 is illustrated as being connected to SSP 310. These IPs may be used for providing functions for interaction between users and the voice network, such as voice mail services, digit collection, customized announcements, voice recognition, etc. Moreover, the communications between the SSP 310 and IP 302 may use the Primary Rate interface (PRi) (e.g., the 1129 protocol) protocol. Additionally, the IP 302 may be capable of sending and receiving information to/from the Service Center 106. These communications may use, for example, the SR-3511 protocol. Further, although FIG. 3 illustrates this connection as a direct connection, this connection may include any number of elements including routers, switches, hubs, etc., and may be via, for example, an internal data network for the voice network 104.

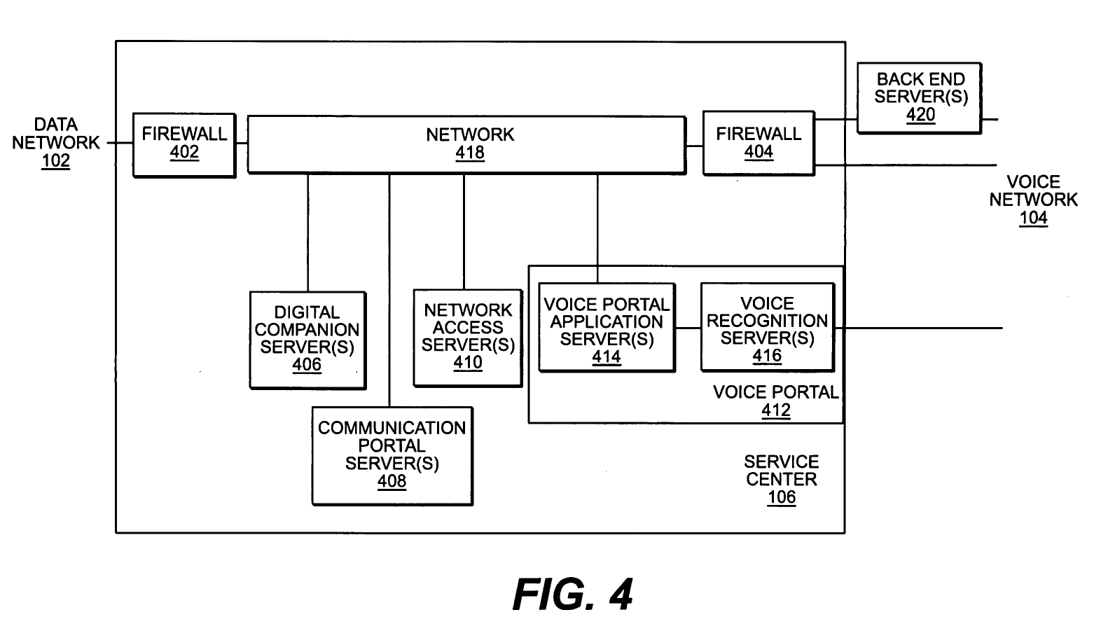

FIG. 4 is a block diagram of a service center, consistent with the principles of the present invention. As shown, service center 106 may include firewalls 402 and 404, one or more digital companion servers 406, one or more communication portal servers 408, one or more network access servers 410, and a voice portal 412. The voice portal 412 may include a voice portal application server 414 and a voice recognition server 416. A network 418 may be used to interconnect the firewalls and servers. Additionally, back end server(s) 420 may be provided between the service center 106 and the voice network 104.

Firewalls 402 and 404 provide security services for communications between service center 106, data network 102, and voice network 104, respectively. For example, firewalls 402 and 404 may restrict communications between user terminal 112 and one or more servers within service center 106. Any appropriate security policy may be implemented in firewalls 402 and 404 consistent with the principles of the present invention. Firewalls 402 and 404 may be implemented using a combination of known hardware and software, such as the Raptor Firewall provided by the Axent Corporation. Further, firewalls 402 and 404 may be implemented as separate machines within service center 106, or implemented on one or more machines external to service center 106.

Network 418 may be any type of network, such as an Ethernet or FDDI network. Additionally, network 418 may also include switches and routers as appropriate without departing from the scope of the invention. Further, additional firewalls may be present in the network 418, for example, to place one or more of servers 406, 408, 410, or voice portal 412 behind additional firewalls.

Each server (406, 408, 410, 414, 416, 420) may be any appropriate type of server or computer, such as a Unix or DOS-based server or computer. The servers may implement various logical functions, such as those described below. In FIG. 4, a different server is illustrated as being used for each logical function. In other embodiments, the logical functions may be split across multiple servers, multiple servers may be used to implement a single function, all functions may be performed by a single server, etc.

In general, a digital companion server 406 may provide the software and hardware for providing specific services of the service center. Exemplary services include, for example, permitting a customer to add contacts to their address book from a history of calls made or received by the customer, permitting a customer to make calls directly from their address book, scheduling a call to be placed at a specific time, or permitting the customer to look at the name and/or address associated with a phone number. Additionally, these services may include permitting the customer to listen to their voice mail on-line, forwarding their calls based on a scheduler and/or the calling parties number, setting up conference calls on-line, real-time call management, etc. In one embodiment, real-time call management enables a user to perform several functions as a call is being received, such as sending a call to voice mail, sending a call received on one device to another device, manually initiating protection from telemarketers, playing an announcement for the caller, scheduling a call back, bridging a caller onto a current call, etc.

A communication portal server 408 may provide the hardware and software for managing a customer's account and interfacing with customer account information stored by the provider of customer's voice network 104. The network access servers 410 may provide the hardware and software for sending and receiving information to the voice network 104 in processing the applications provided by the service center. For example, the network access servers 410 may be used for transmitting and/or receiving information from/to an ISCP 302 or an SSP 308 or 310 of the voice network 104.

The voice portal 412 includes software and hardware for receiving and processing instructions from a customer via voice. For example, a customer may dial a specific number for the voice portal 412. Then the customer using speech may instruct the service center 105 to modify the services to which the customer subscribes. The voice portal 412 may include, for example, a voice recognition function 416 and an application function 414. The voice recognition function 416 may receive and interpret dictation, or recognize spoken commands. The application function 414 may take, for example, the output from the voice recognition function 416, convert it to a format suitable for the service center 106 and forward the information to one or more servers (406, 408, 410) in the service center 106.

FIG. 3 illustrates a logical architecture of an exemplary system, consistent with the present invention. As illustrated, the logical architecture may be split into four planes: client side 502, application service 504, network access 506, and the voice network 508.

Client side 502 includes user terminals 112_A and 112_B that a user may use to send and/or receive information to/from the service center 106. Additionally, client side 502 includes the user's phone(s) 114. As discussed above, user terminals 112 may be any type of device a user may use for communicating with Service Center 106. For example, user terminal 112_A may be a PDA running a program for communicating with the Service Center 106, while user terminal 112_B may be a desktop type computer running a web browser for communicating with the Service Center 106 via the Internet. Additionally, the user may have one or more phones 114, such as, for example, one or more standard landline telephones and/or wireless phones.

The application service plane 504 includes the digital companion server(s) 406, communication portal server(s) 408, and the voice portal 412. These entities may communicate between one another using, for example, web services or any other suitable protocols. Web services are a standardized way of integrating Web-based applications using the Extensible Markup Language (XML), Simple Object Access Protocol (SOAP), Web Services Description Language (WSDL) and Universal Description, Discovery and Integration (UDDI) open standards over an Internet protocol (IP) backbone.

As illustrated, a digital companion server 406 may provide the following functions: a client proxy 512, a web server 514, an application server function 516, a calendar server function 518, a notification server function 520, and a database function 522. Each of these functions may be performed in hardware, software, and/or firmware. Further, these functions may each be executed by a separate server, split across multiple servers, included on the same server functions, or any other manner.

The client proxy function 512 provides a proxy function for the digital companion that may be used for security purposes. This client proxy function 512 may be included in a separate server such that all communications sent from the other digital companion functions/servers to a user terminal 112 via the data network 102 go through the client proxy 512. Also, if the client proxy 512 is included on a separate server, for example, an additional firewall may be provided between the client proxy 512 and the other digital companion servers to provide additional security.

Web server 514 provides functionality for receiving traffic over the data network 102 from a customer. For example, web server 514 may be a standard web server that a customer may access using a web browser program, such as Internet Explorer or Netscape Communicator.

Application server function 516 encompasses the general functions performed by the digital companion server(s) 406. For example, these functions may include interfacing with the various other digital companion functions to perform specific services provided by the service center. These services may include, for example, interfacing with other function(s), software, and/or hardware to provide a customer with the capability of managing their calls online. For example, permitting a customer to add contacts to their address book from a history of calls made or received by the customer, permitting a customer to make calls directly from their address book, scheduling a call to be placed at a specific time, or permitting the customer to look at the name and/or address associated with a phone number. Additionally, these services may include permitting the customer to listen to their voice mail on-line, forwarding their calls based on a scheduler and/or the calling parties number, setting up conference calls on-line, enabling call management with user intervention in real-time, etc.

Additionally, the application server function 516 may interface with one or more external devices, such as an external web server, for retrieving or sending information. For example, the application server function 516 may interface with a voice network's data center 556 (e.g., verizon.com) to determine the services to which the customer subscribes (e.g., call waiting, call forwarding, voice mail, etc.).

Calendar server function 518 may provide the capability of scheduling events, logging when certain events occurred, triggering the application-functions to perform a function at a particular time, etc.

Notification server function 520 provides the capability to send information from the service center 106 to a user terminal 112. For example, the notification server function 520 at the direction of the application server function 516 may send a notification to the user terminal 112 that the user is presently receiving a phone call at the user's phone 114. This notification may be, for example, an instant message pop-up window that provides an identification of the caller as well as the number being called. The notification may also have a number of user-selectable buttons or items associated with it that enable the user to manage a call in real-time.

Database function 522 provides the storage of information useable by the various applications executed by the digital companion servers. These databases may be included in, for example, one or more external storage devices connected to the digital companion servers. Alternatively, the databases may be included in storage devices within the digital companion servers themselves. The storage devices providing the database function 522 may be any type of storage device, such as for example, CD-ROMs, DVD's, disk drives, magnetic tape, etc.

As discussed above, the communication portal server(s) 408 provide the hardware and software for managing a customer's account and interfacing with customer account information stored by the provider of customer's voice network 104. As illustrated in FIG. 3, a communication portal server 408 may provide the following functions: a web server function 526, an application server function 528, a contacts database function 530, and/or a customer profile function 532. Each of these functions may be performed by a separate server, split across multiple servers, included on the same server functions, or any other manner.

Web server function 526, as with web server function 514 of the digital companion servers, provides functionality for receiving traffic over the data network 102 from a customer. For example, the web server may be a standard web server that a customer may access using a web browser, such as Internet Explorer™ or Netscape Communicator™.

The application server function 528 encompasses the general functions performed by the communication portal servers 408. For example, these functions may include interfacing with the voice network to retrieve and/or modify customer profile information, and creating and editing an address book for the user. Additionally, the application server function 528 may include the functionality of sending and/or receiving information to/from external servers and/or devices. For example, the communication portal servers 408 may be connected to a network, such as, the Internet. The application server function 528 may then provide connectivity over the Internet to external servers 552 that provide web services, such as the Superpages web page. The application server function 528 could then contact these external services 552 to retrieve information, such as an address for a person in the user's address book.

In another example, the application server function 528 of the communication portal 408 may interface a single sign on (SSO) server 554. SSO 554 may be used to allow users to access all services to which the user subscribes, on the basis of a single authentication that is performed when they initially access the network.

Moreover, the application server function 528, similar to application server 516, may provide functionality to facilitate services performed by the service center. These services may include, for example, interfacing with other function(s), software, and/or hardware to provide a customer with the capability of managing their calls online. For example, permitting a customer to add contacts to their address book from a history of calls made or received by the customer, permitting a customer to make calls directly from their address book, scheduling a call to be placed at a specific time, or permitting the customer to look at the name and/or address associated with a phone number. Additionally, these services may include permitting the customer to listen to their voice mail on-line, forwarding their calls based on a scheduler and/or the calling parties number, setting up conference calls on-line, enabling call management with user intervention in real-time, etc.

The contacts database 530 includes storage devices for storing an address book for the user. This address book may be any appropriate type of address book. For example, the user's address book may include the names, phone numbers, and addresses of people and/or organizations. These storage devices may be internal or external to the communication portal servers 406 or some combination in between. In addition, these storage devices may be any type of storage device, such as magnetic storage, memory storage, etc.

The customer profile database 532 includes storage devices for storing customer profile information for the user. These storage devices may be the same or separate storage devices used for the contacts database. The customer profile may include information regarding the user's account for their voice network. For example, this information may include the user's name, billing address, and other account information. Additionally, the customer profile may include information regarding voice services to which the user subscribes, such as, for example, call waiting, voice mail, etc.

The application services plane 504 of the architecture may also include a voice portal 412. As discussed above, the voice portal 412 may include, for example, a voice recognition function 416 and an application server function 414, and be used for receiving and processing instructions from a customer via voice. The voice recognition function may be implemented using hardware and/or software capable of providing voice recognition capabilities. This hardware and/or software may be a commercially available product, such as the Voice Application platform available from Tellme Networks, Incorporated. The application server function 414 of the voice portal 412 may include hardware and/or software for exchanging information between the digital companion servers 406 and the voice recognition function 416. Additionally, the application server function 414 may be included on a separate server, included in the hardware and software providing the voice recognition function 416, included in the digital companion servers 406, etc.

The Network Access plane 506 of the architecture includes the functions for providing connectivity between the application service plane 502 and the voice network 104. For example, this plane may include the recent change engines 316, network access servers 410, and/or back end servers 420.

As discussed above, recent change engines 316 may be used to update switches and ISCP databases included in the voice network 104. In one embodiment, the recent change engines 316 may include an AAIS 544, an eRC 546, and/or an MSP 548. Additionally, a proxy 542 may be used between the digital companion servers 406 and the recent change engines 542 for security purposes.

The network access servers 410 may be included in the service center 106 and may provide the hardware and software for sending and receiving information to the voice network 410 in processing the applications provided by the service center. For example, the network access servers 410 may include a Caller ID (CID) functionality for retrieving caller ID information from the voice network 104, a click to dial (CTD) functionality for instructing an intelligent peripheral (IP) in the voice network to place a call via an SSP, and/or a real time call management (RTCM) functionality for interfacing with an ISCP of the voice network.

Network Access plane 506 may also include one or more back end server(s) 420. These back end server(s) 420 may include hardware and/or software for interfacing the service center 106 and the voice network 104. The back end server(s) 420 may be connected to the service center 106 by a network, by a direct connection, or in any other suitable manner. Further, the back end server(s) 420 may connect to one or more devices in the voice network 104 by a network, a direct connection, or in any other suitable manner.

The back end server(s) 420 may include, for example, a server providing a voice mail retrieval and notification function. This voice mail retrieval and notification function may include the capability to receive notifications when a user receives a voice mail, physically call a user's voice mail system, enter the appropriate codes to retrieve the voice mail, retrieve the voice mail, convert the voice mail to a digital file, and send it to the digital companion servers 406.

Additionally, these back end server(s) 420 may also include, for example, a directory assistance server. This directory assistance server may interface the service center 106 with a Reverse Directory Assistance Gateway (RDA Gateway) of the voice network 104. An RDA Gateway is a device for issuing requests to a Data Operations Center (DOC) of the voice network 104 for name and/or address information associated with a phone number and receiving the name and/or phone number in response to this request.

In another example, the back end server(s) 420 may include a wireless internet gateway that is used for interfacing with a mobile switching center (MSC) of a wireless voice network. As with the above-described back end server(s) 420, this wireless internet gateway may be used for converting requests and information between the formats used by the service center 106 and those used by the wireless voice network.

In yet another example, the back end server(s) 420 may include a conference blasting server for instructing a conference bridge in the voice network 106 to dial out via an SSP to the participants of a voice conference. Alternatively, for example, the back end server(s) may include a server for instructing an IP of the voice network to place a call between two parties by dialing out to each of the parties. The back end server(s) may also include the capability to instruct the bridge or IP device to call an audio digitizing device that can listen to the conference, convert the audio signals to digital format, and forward the digitized signals to a user device via, for example, an audio streaming server. The audio streaming server may, for example, allow a user to connect to it via, for example, the Internet. Additionally, the audio streaming device may buffer or record the signals to permit the user to pause, rewind, and/or fast-forward thru the conference.

In yet another example, the back end server(s) 420 may include a Single Number Short Message Service (SN SMS) server for interfacing the service center 106 with a Short Message Service (SMS) gateway in the voice network 104. This may be used to permit the customer to have SMS messages addressed to their home phone number directed to an SMS capable device of the users choosing.

The voice network plane 508 includes the hardware and software included in the voice network 104, as discussed above with reference to FIG. 3. For example, the voice network plane 508 may include the ISCP SPACE 314, the ISCP 302, the intelligent peripherals 320, and the SSP 308. Additionally, the voice network plane 508 may also include the hardware and software included in a wireless carrier's network, such as, for example, the mobile switching center, etc.

In one aspect of the present invention, a plurality of user access points, including, but not limited to, a website, a desktop client, a voice portal, a PDA portal, a PPA portal (e.g., Outlook or Lotus), or any other suitable portal may be provided at, for example, a PDA, a cell phone, an integrated phone such as Verizon One, a HDTV/PVR, a PC, or any other suitable access device capable of connecting to an integrated network, such as shown in FIG. 3. Each access device for implementing a user access point may be consistent with descriptions of phone 114 and/or user terminals 112A and 112B. A user, at a user access point, may access services and applications provided by application service and business logic 504. The services provided by application service/business logic 504 may include aggregated financial services.

In an exemplary embodiment of the present invention, aggregated financial services may be provided by an external web-based service 552. The aggregated financial services may enable the user to centrally manage a variety of dispersed financial accounts, including bank accounts, brokerage accounts, credit card accounts, frequent flyer accounts, reward programs, and any other accounts in connection with the user's financial position. Secure access to the multiple financial services may be achieved using a single user credential.

Generally speaking, a credential is a verified identification of a user. The credential may be, for example, a user id and password pair, a private encrypted key, or any other suitable verified identification. In one suitable embodiment, a single sign-on server, such as SSO server 554, may enable a user to seamlessly log into multiple financial service sites where the user has access permission. The single credential authentication, as carried out by SSO server 554, may be implemented in a variety of ways. As one example, a secret store or suitable database may be provided, for example, in customer profile 532 of communication portal 408 or another suitable location to which SSO server 554 has access. The secret store may house various unique authentication credentials associated with the user's various financial accounts. The stored credentials may be individually encrypted and automatically retrieved and provided by SSO server 554 to a requesting service site to gain access to the user's financial account information. In this way, information associated with the user's financial accounts at different financial service sites may be retrieved without requiring the user to go through separate log in processes. In summary, as long as the user is authenticated to SSO server 554, SSO server 554 may manage the rest of the user's log in processes. In some embodiments of the present invention, SSO authentication may be implemented according to the Security Assertion Markup Language (SAML) standard.

Once access to the user's various financial accounts is established, typically by receiving and authenticating a credential, information may be gathered for providing aggregated financial services. The aggregated services may include, for example, allowing the user to review account activities, balances, transactions, and other suitable financial information associated with the various financial accounts. In some embodiments of the present invention, the user may select an account to view information that is specific to that account. Alternatively, the user may simultaneously view a presentation of information associated with multiple accounts. Yet another option is that the user may view account information that is a consolidation of the information from multiple accounts.

A suitable embodiment for providing aggregated financial services may be, for example, an external web-based service 552, such as checkfree.com or yodlee.com. The web-based service 552 may, for example, communicate with communication portal 408 to obtain necessary user information. The web-based service 552 may also utilize SSO server 554 or another independent or otherwise suitable server for authenticating the user to the user's various financial accounts.

In some embodiments of the present invention, aggregated financial services may be provided by application servers that are integrated into, for example, digital communication portal 408 or digital companion 406. In these embodiments, external providers of financial services or financial institutions, such as banks, credit card companies, investment banks, etc., may authorize and provide the user's account information to the suitable application server in the network. In this way, a single user credential is sufficient to gain access to the user's financial account information maintained by a plurality of financial services.

Regardless of the authentication method, once authentication is completed, information from the user's various accounts may be obtained and consolidated to provide aggregated financial services. The user may use one or more of the user's user access points to gain access to the consolidated account information. As an example, a user, using a Verizon One phone or another suitable user access point implemented on a device that is consistent with user terminals 112_A and 112_B, may access, for example, web-based service 552 to view consolidated account information.

### TV-Based Network Overview

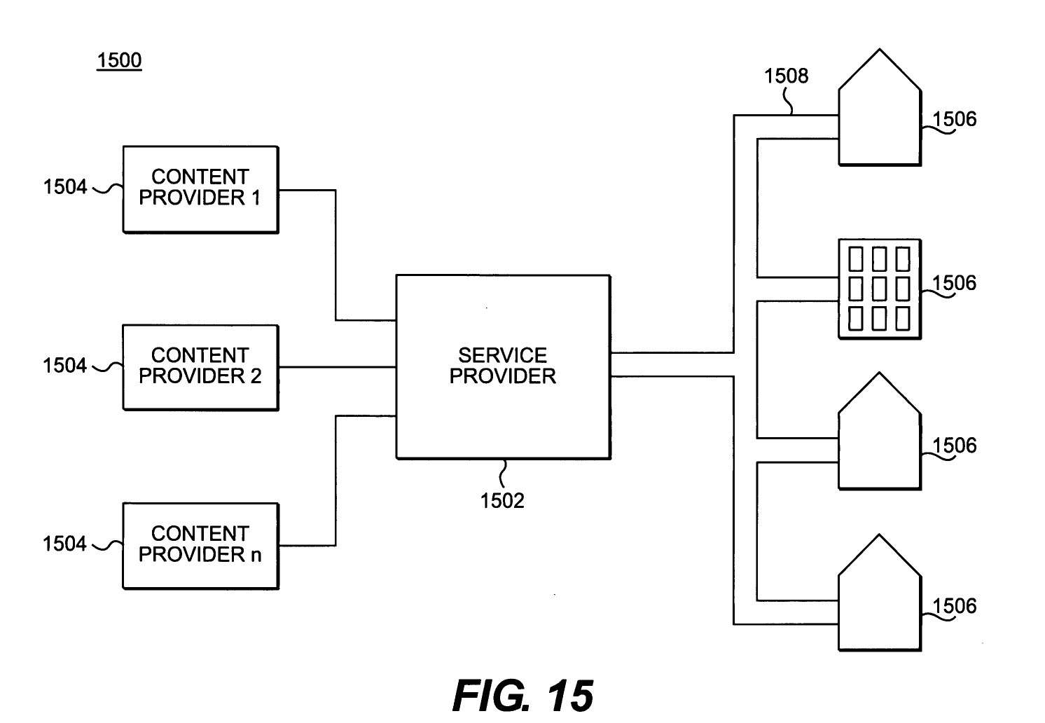

FIG. 15 is a block diagram of a system 1500 consistent with the principles of the present invention. A service provider 1502 collects television content (e.g., broadcast video, broadcast audio, audio/video on demand, data content), from a plurality of content providers 1504. Such content may include, for example, programming from local broadcast television channels, programming from national broadcast television content providers such as Home Box Office or ESPN, and educational programming such as distance learning broadcasts. Service provider 1502 transmits data, including the audio/video content, to subscribers 1506 via an access network 1508. Subscribers 1506 may include homes, businesses, hotels, etc. In the preferred embodiment, access network 1508 consists of fiber optic cables and connectors, enabling high speed, two-way communication between service provider 1502 and subscribers 1506. In one embodiment, service provider 1502 and subscribers 1506 may also be able to communicate via alternate networks that may interconnect the service provider 1502 and subscribers 1506, such as the Internet, data/voice network as described above, and any other suitable network (not shown).

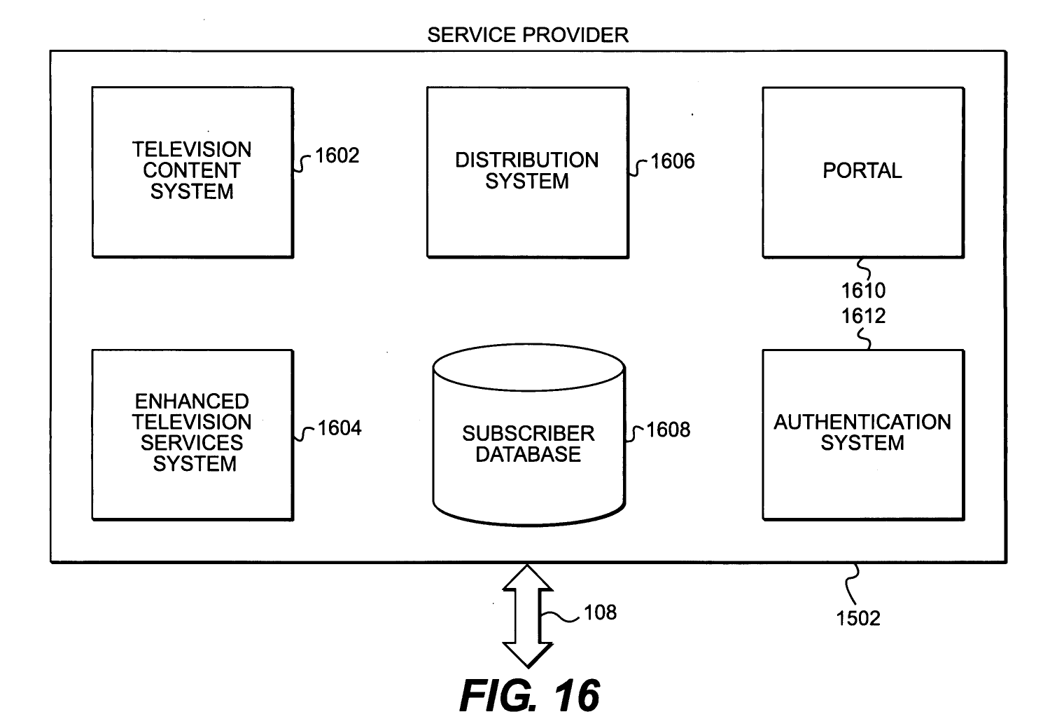

FIG. 16 is a block diagram of a service provider 1502 consistent with the principles of the present invention. Service provider 1502 may provide multiple services to subscribers 1506. For example, service provider 1502 may establish and maintain subscriber accounts including aggregated financial accounts, which are described in more details below, provide regular broadcast television programming, provide on-demand video content, enable subscriber feedback, etc. Service provider 1502 may also enable subscribers 1506 to obtain enhanced services, such as aggregated financial services, which will be described in more details below.

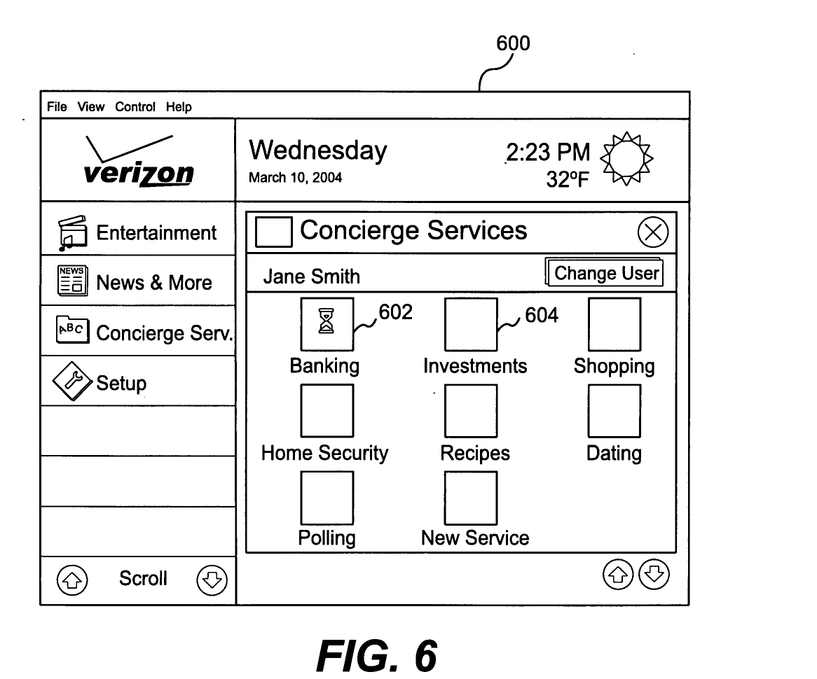

Exemplary service provider 1502 may include systems and facilities to receive, store, process and transmit content for provision to subscriber 1506. For example, exemplary service provider 1502 may include a television content system 1602, an enhanced television service system 1604, a distribution system 1606, a subscriber database 1608, a portal 1610, and an authentication system 1612. Television content system 1602 may receive, store, process and transmit broadcast television content originated by content providers 1504. In one embodiment, service provider 1502 may also create television content and store and transmit such content using television content system 1602. Enhanced television services system 1604 may receive, store, process and transmit data to support enhanced television services, including aggregated financial services, and provide subscriber interfaces, such as those discussed below in connection with FIGS. 6-11, for accessing and interacting with aggregated financial services and other enhanced television services.

Distribution system 1606 may distribute content and data, e.g., from television content system 1602 or enhanced television services system 1604, to subscribers 1506. Distribution system 1606 may perform broadcast/multicast delivery (e.g., to send the same information to many subscribers simultaneously) or unicast delivery (e.g., to send customized content to a single subscriber). Distribution system 1606 may also provide an “upstream” communications path from subscribers 1506 to, for example, enhanced television services system 1604, such that subscribers may send requests and other information related to obtaining customized content.

Subscriber database 1608 may store data about subscribers 1506 such as name, address, subscriptions to enhanced services, etc. More specifically, subscriber database 1608 may house those unique authentication credentials associated with the subscriber's various financial accounts as described above in connection with the data/voice network environment. The stored credentials may be individually encrypted and automatically retrieved and provided, for example, by a suitable SSO server included within or in communication with authentication system 1612, to a requesting service site to gain access to the user's financial account information. Portal 1610 may provide an interface for communications with service provider 1502 via an external network, such as the PSTN or a wide area network such as the Internet. Authentication system 1612 may process authentication and/or authorization information to enforce security and privacy for providing enhanced services, such as aggregated financial services, to subscribers 1506. In some embodiments, authentication system 1612 may serve as the SSO server or may be in communication with a suitable SSO server to enable access to the subscriber's various financial accounts.

A skilled artisan will recognize that service provider 1502 may include more or fewer components than are shown in FIG. 16. For example, a separate database may be provided to store authentication information used by authentication system 1612. In another example, service provider 1502 may include telecommunications and/or conference bridge facilities to enable subscribers 1506 to access audio/video teleconference services (e.g., available through enhanced television services). Additionally, the functionality of service provider 1502 may be performed by a single system, or by a combination of computers and other equipment, which may be distributed over multiple locations and interconnected by various communication links. The operation of the components of service provider 1502 is described in greater detail below in connection with FIGS. 6-14.

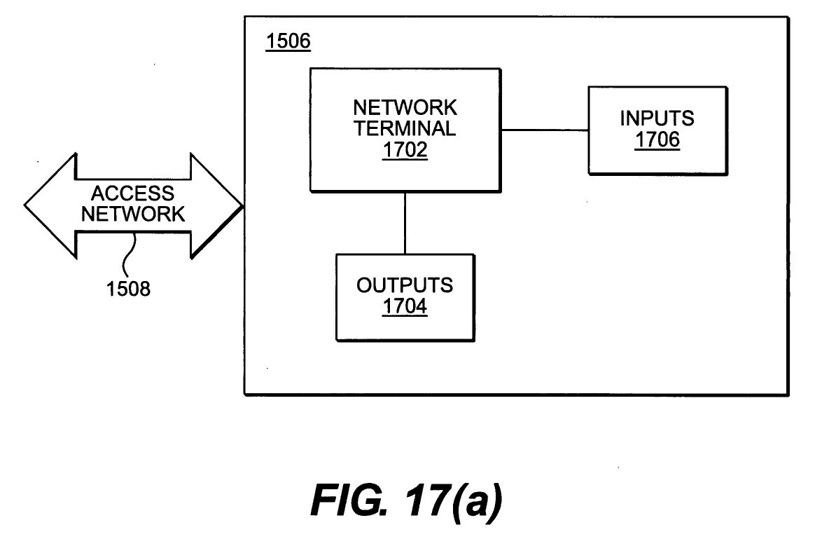

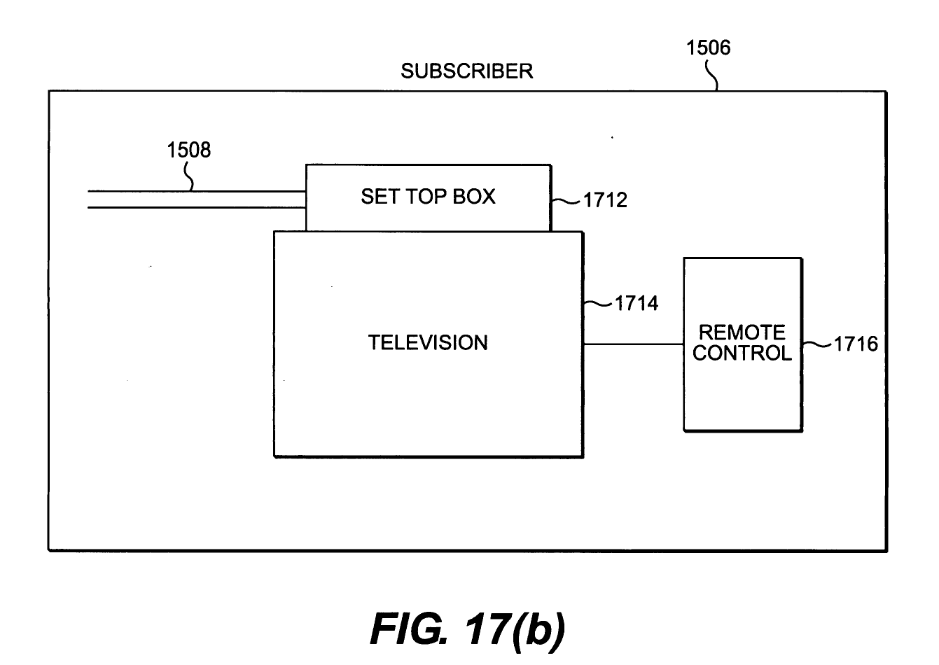

FIG. 17(a) and 17(b) illustrate block diagrams of a subscriber 1506 consistent with the principles of the present invention. As shown in FIG. 17(a), subscriber 1506 receives transmissions from service provider 1502 via access network 1508 at a network terminal 1702. As described above, access network 1508 may be, for example, a passive optical network (PON). The network terminal 1702 may receive the network transmissions from service provider 1502 via any number of intermediate components/technologies. For example, an optical-to-electrical conversion component may be interposed between the network terminal 1702 and service provider 1502 in order to convert optical transmission to electrical signals (e.g., RF signals, POTS signals, Ethernet signals), as well as other transport components that may be deployed therebetween.

Network terminal 1502 processes data received via access network 1508 and presents it to output device 1704. As such, network terminal 1702 may include processors, storage systems, network interfaces (e.g., to access network 1508) and device interfaces, as generally known. Output devices 1704 can include any number of components with the capabilities to output audio/video, such as video displays, speakers, etc. Network terminal 1502 is also connected to one or more input devices 1706, which allow users to provide input data, for example to control the network terminal 1702 or output devices 1704, or provide data for upstream transmission over access network 1508. Input devices 1706 can include devices such as keyboards, pointing devices, remote controllers, touch screens, etc. In certain embodiments, network terminal 1702 may be integrated with any or all of the output devices 1704, as well as any or all of the input devices 1706 (an example of which would be a mobile telephone). In some embodiments, subscriber 1506 may also use a separate computing system or telecommunications device such as a Verizon One phone, a PDA, or another suitable user access device (not shown) connected to an external network (e.g., PSTN, Internet, wireless network) to communicate with service provider 1502 (e.g., via portal 1610).

FIG. 17(b) illustrates a specific embodiment relative to typical television service at a subscriber 1506. As shown in FIG. 17(b), the network terminal is a set top box 1712 connected to access network 1508 (e.g., via various technologies/components) to communicate with service provider 1502. Set top box 1712 is connected to television 1714, which includes facilities to display video and produce audio based on signals provided by set top box 1712. A remote control 1716 and other input devices (e.g., pushbuttons) are provided and may be connected to television 1714 and/or set top box and to provide data which may be transmitted over access network 1508 to service provider 1502, and/or other subscribers 1506.

Subscriber 1506 may set up an account with service provider 1502 which enables and/or control the ability to receive enhanced television services, such as aggregated financial services. For example, the subscriber account may be used by provider 1502 to store subscriber identification information, such as name, address, authentication information for accessing various financial accounts, store indications of which services a subscriber is authorized to receive, such as premium channels, aggregated financial services, or Internet access, and track and bill for enhanced services, such as viewing of personal content, etc. The account may also store an identifier of the subscriber's network terminal 1702 that allows for identification of the network terminal over the access network 1508 (e.g., a unique identifier of a set top box 1712 assigned to the subscriber), facilitating the delivery of enhanced television services, including aggregated financial services, to the subscriber. Subscriber 1506 may access account information, for example, using portal 1610 via voice communications (e.g., an interactive voice response system) or data communications (e.g., an interactive web interface over the Internet). Alternatively, a subscriber may use a phone, such as a Verizon One phone, which is integrated into or otherwise in communication with set top box 1812 or controls available in remote control 1816 to communicate with service provider 102 over access network 1508.

Subscriber 1506 may include several users. For example, within a single household, different family members may desire to receive different content or subscribe to different enhanced television services, including access to aggregated financial services, from service provider 1502. In one embodiment, a subscriber 1506 (e.g., a household) may establish an account with service provider 1502 and each user (e.g., family members in the household) is associated with that account and may have information, such as authentication information, stored associated with the account in subscriber database 1608. In another embodiment, each user may establish his own account, including an aggregated financial service account with service provider 1502.

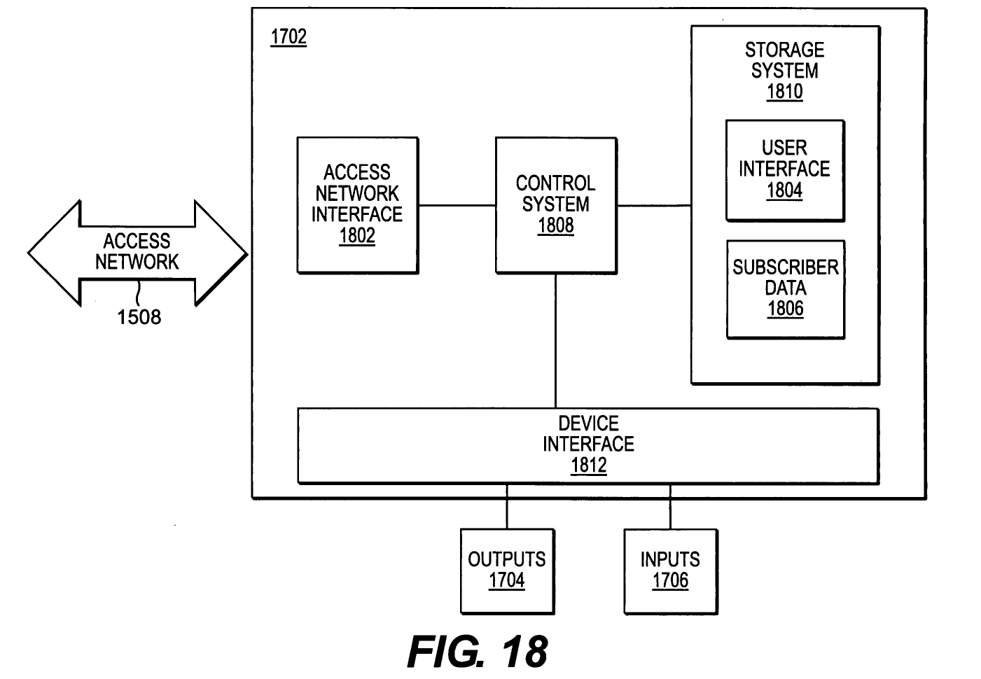

FIG. 18 is a detailed block diagram of a network terminal 1702 (such as set top box 1712) consistent with an embodiment of the present invention. Network terminal 1702 may include an access network interface 1802, control system 1808, storage system 1810 and device interface 1812. Control system 1808 may include processors or other control logic, which may be used to execute various instructions and manipulate data stored in storage system 1810. Storage 1810 may include various storage devices and controllers, such as semiconductor memories (e.g. RAM, ROM, flash), magnetic memories (e.g., disk), optical memories (e.g., DVDs), memory controllers and/or other storage, as is well known. Device interface 1812 may include various components to interface with external components, such as output devices 1704 and input devices 1706, as generally known.

Using the access network interface 1802, network terminal 1702 communicates with service provider 1502 to send and receive high speed communications for television programming, enhanced television services, including aggregated financial services, subscriber account management, etc., over access network 1508. Access network interface 1802 may include various components to allow for communications over access network 1508 in one or more forms, depending on implementation. For example, access network interface 1508 may include an RF interface to receive RF signals and/or an optical interface to receive optical signals. Access network interface 1802 may further include components to distinguish between and process various communications carried over access network 1508. For example, access network interface 1802 may include components to receive broadcast television formatted transmissions (e.g., NTSC, MPEG) and/or packet data formatted transmissions (e.g., Ethernet, IP). In some embodiments, access network interface 1802 may also be connected to device interface 1812, for example, to provide broadcast television transmissions to output devices 1704.

Storage system 1810 may include various modules executable by the control system 1808 and implementing various features in the preferred embodiment. For example, storage system 1810 stores a user interface 1804 for providing one or more displays, such as the displays shown in connection with FIGS. 6-11, which may be displayed on output devices 1704 to enable subscriber 1506 to, for example, interact with enhanced services, such as aggregated financial services. User interface 1804 may include various user interfaces to utilize enhanced television services available through service provider 1502, for example, downloaded from service provider 1502. Subscriber data 1806, such as authentication information for aggregated services, may also be stored in storage system 1810 to support enhanced television services. For example, a subscriber's viewing preferences or settings may be stored as subscriber data 1806. In another example, subscriber data 1806 may be stored outside network terminal 1702, such as at service provider 1502 (e.g., in subscriber database 1608) or on a computing system or other device controlled by the subscriber (e.g., a smart card).

Network terminal 1702 may include fewer or more components than are shown in FIG. 18, as is well known, and may be interconnected in various ways using buses, etc., is well known.

Consistent with the present invention, a high-bandwidth bidirectional access network 1508 is used to provide enhanced television services. For example, a service provider may provide a multitude of enhanced services, such as aggregated financial services, to a subscriber by allowing the subscriber to connect with the service provider via such a high-bandwidth bidirectional access network to obtain, configure and control the delivery of desired content and services. The preferred embodiment utilizes a fiber optic network, although other technologies could also be used (e.g., RF wireless, RF over coaxial cables). Fiber optic connections provide much more bandwidth for transmitting data than conventional connections such as radio waves or coaxial cable. Fiber, for example, can easily carry hundreds or even thousands of channels of television content, telephone services, and data services (e.g., Internet access). To leverage the additional bandwidth and quality of fiber connections, service providers may offer a wide range of enhanced television services, including aggregated financial services, to attract and retain subscribers.

In addition to aggregated financial services enhanced television services may include, for example, personalized television channels, synchronized sharing of personal content among subscribers, direct access to supplemental television content, integrated chat and presence information on television, and interactive entertainment. Subscribers may enjoy these services from the comfort of home using familiar devices (e.g., a television, a remote control, etc.). In some embodiments, subscribers may have the option of using a computer connected to the Internet to further customize or enhance television services. Alternatively or in addition, subscriber may use a Verizon One phone, a PDA, or any other suitable access point devices to access, customize, or enhance television services, including aggregated financial services.

FIGS. 6-11 show some exemplary screens that may be displayed to a user in connection with consolidated account information consistent with one or more of the network environments and systems described above.

FIG. 6 shows an illustrative concierge services screen 600 that may be displayed to the user at a user access point, such as one implemented on a Verizon One phone, a television, or any other suitable user access point, in accordance with one embodiment of the present invention. In screen 600, banking option 602 and investments option 604 are shown as separate buttons. In some embodiments of the present invention, banking option 602 and investment option 604 may be combined into a single financial services option.

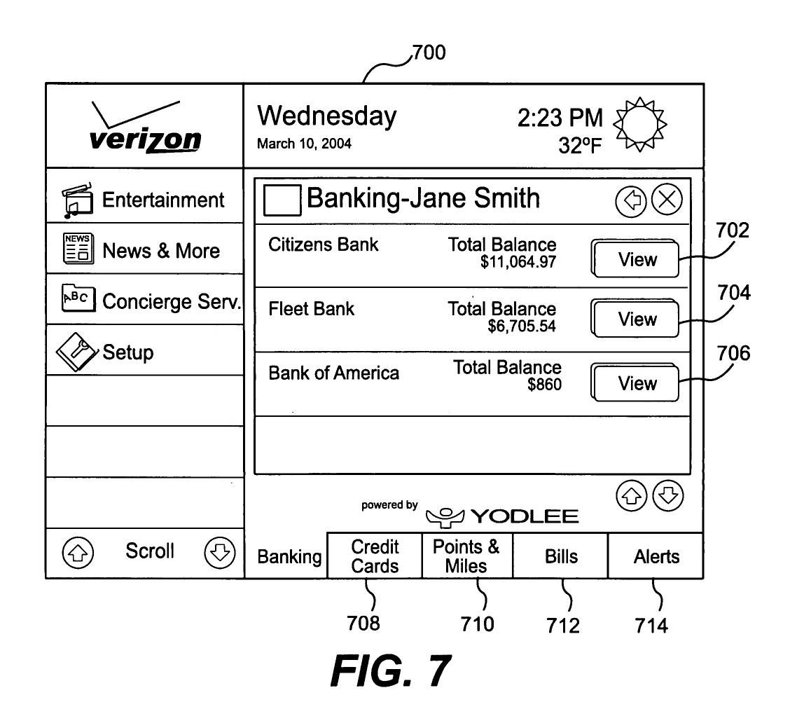

In response to the user selecting banking option 602, banking screen 700, as shown in FIG. 7 may be displayed. In screen 700, banks where the user has established accounts may be listed, for example, with the user's total balance at that bank. The user may view additional information on the accounts at a particular bank by, for example, selecting corresponding view buttons 702-706.

When an aggregated financial service, such as banking service, is selected by the user, links to other aggregated services may also be presented on the screen. In screen 700, other aggregated financial services are displayed as buttons 708-714. In this way, the user may access other related services without returning to the main services screen.

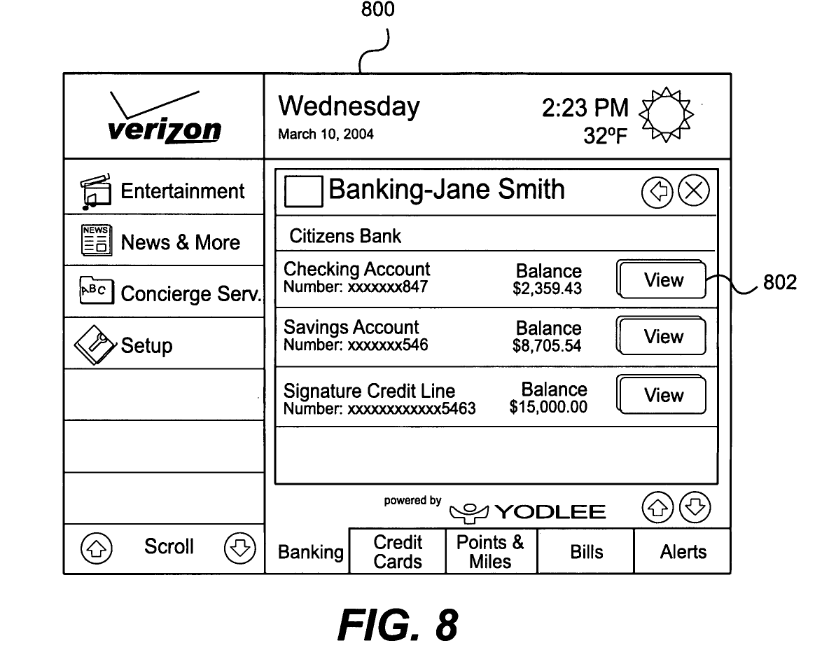

In response to a user selecting view button 702 in connection with the user's accounts at a financial institution, such as Citizens bank, screen 800 of FIG. 8 may be displayed. In screen 800, each of the user's accounts at Citizens bank may be listed with its corresponding balance. A history/view button 802 may be provided for each account. The user may select history/view button 802 to view, for example, account activities, such as last transactions, in the selected account.

FIGS. 6-8 are merely illustrative of screens that may be displayed to a user in connection with provision of aggregated financial services at a user access point implemented, for example, on a Verizon One phone, a television, or any other suitable access device. Any other suitable screens may be used in both banking-related and other financial services-related displays at a variety of user access points without departing from the spirit of the present invention.

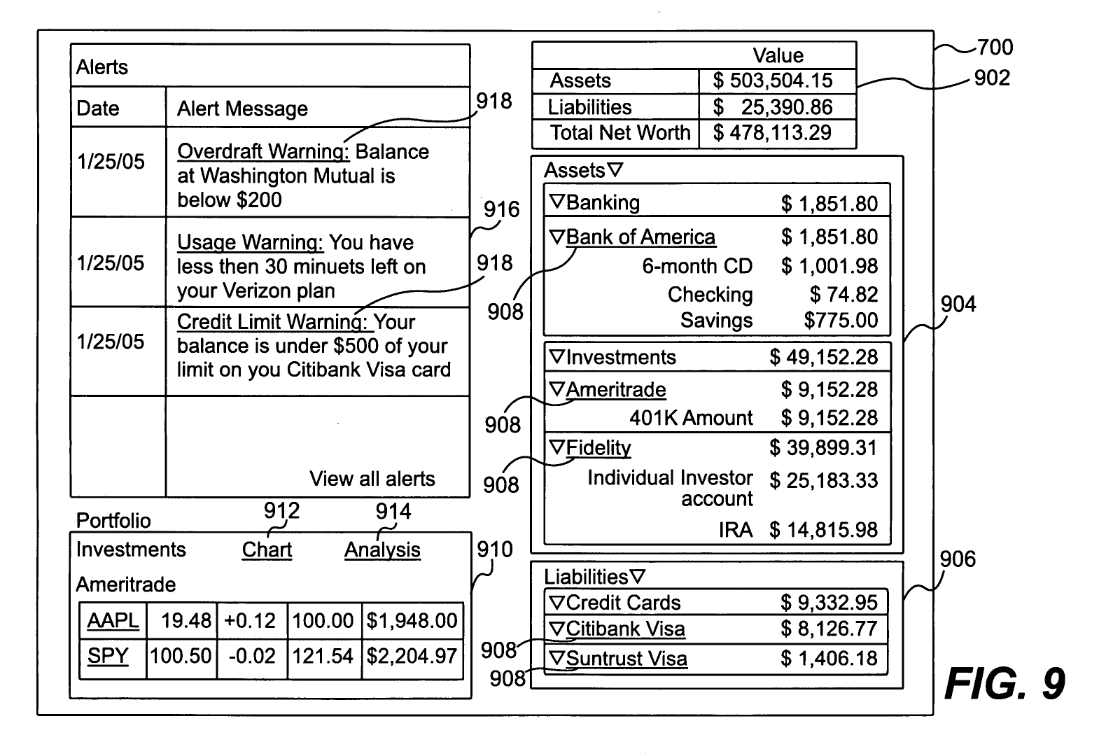

As an alternative to the screens of FIGS. 6-8, in which banking, investments, bill payments, and other aggregated financial services are displayed on separate screens, FIG. 9 shows an exemplary summary screen 900 in which the user's assets and liabilities from the various user accounts, including bank accounts, brokerage accounts, and credit card account, etc., are consolidated and displayed together. The user's combined financial position calculated from all of the user's accounts is displayed in a total net worth section 902. Summary information for each account that contributes to the user's asset is displayed in table 904. Similarly, summary information of accounts that contribute to the user's liabilities is shown in table 906. Links 908 or other suitable mechanisms may be provided to allow the user to select a particular account for obtain additional information.

Additionally, a real-time portfolio 910 may be provided on screen 900 to display investments in the user's various brokerage accounts. The user may chart and perform analysis of portfolio 910, for example, using links 912 and 914. Investment instruments, such as stocks, which are shown in portfolio 910, may be listed with their prices and quantities in real time and may be selectable to allow the user to access additional information.

Screen 900 may also provide an alert section 916. In this section, warnings, notifications, reminders, and any other alerts associated with the user's various financial accounts may be listed, for example, according to their due dates. The user may select an alert to obtain additional information, for example, using link 918. In some embodiments of the present invention, alerts that have not been opened and viewed by the user may appear bold. Additional description of alerts and notifications may be found below in connection with discussion of delivery of notification to a user access point, such as a Verizon One phone or a television.

FIG. 9 is merely illustrative of such a display screen consistent with the various systems and environments described herein. Any other suitable alternative may be used without departing from the spirit of the present invention. For example, tables containing alerts, total net worth, assets, liabilities, and portfolio, may be provided separately on different screens or arranged in any other combination. Information in each section or table may also be simplified or supplemented. In some embodiments of the present invention, screen 900 may be customizable by the user. Alternatively, display of such information may be automatically adjusted to achieve the best presentation at a particular user access point at which the user is accessing the information. For example, on a television screen capable of displaying a large amount of information with graphic elements, color and tables may be included. On a PDA or cellular phone that has a smaller screen, tables of screen 900 may be simplified and displayed separately, for example, in response to user selection of, assets, liabilities, alerts, etc.

An alternative to viewing the consolidated account information at a user access point is to access the aggregated account information through a voice enabled user access point, such as phone 114 or network terminal 1702. The user's phone or network terminal may communicate with the aggregated service provider, such as web-based service 552 or enhanced television services system 1604, for example, through voice portal 412 or access network 1508. The consolidated financial information from the user's accounts may be translated into voice messages and provided to the user at phone 114 or network terminal 1702, for example, using voice recognition 416 or any other suitable mechanism.

In an exemplary embodiment of the present invention, aggregated financial services may additional include allowing the user to carry out financial transactions in connection with the various accounts through one or more of the user access points. For example, the user may pay or schedule bills to be paid, request copies of statements or checks, transfer funds between multiple accounts, trade stocks or other investment instruments, and perform any other suitable financial transactions or combination thereof. Bill payments and fund transfers are discussed below as examples of this type of transactions in accordance with the present invention.

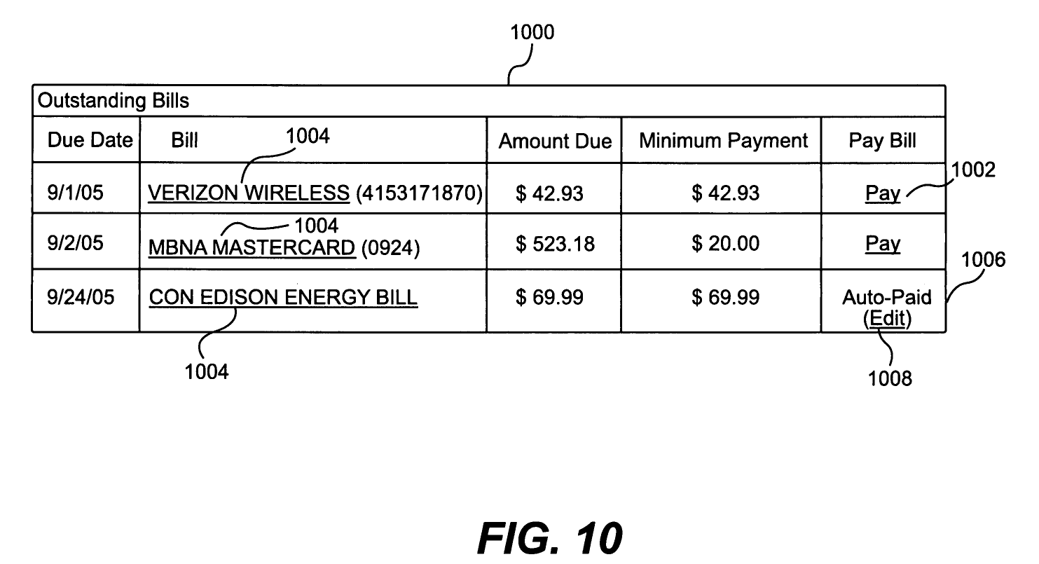

FIG. 10 is an exemplary screen 1000 showing a list of a user's outstanding bills in connection with the user's various accounts in accordance with one embodiment of the present invention. The list of outstanding bills may be sorted, for example, according to their due dates. Both the amount that is actually due and the minimum payment required of each bill may be displayed. Links 1002 may be provided in screen 1000 to facilitate easy bill payments. The user may access additional information about the bill, for example, by clicking on the underlined bill names 1004. One of the bills 1006 has an associated auto-payment program. The user may edit the auto-payment program, for example, using edit link 1008.

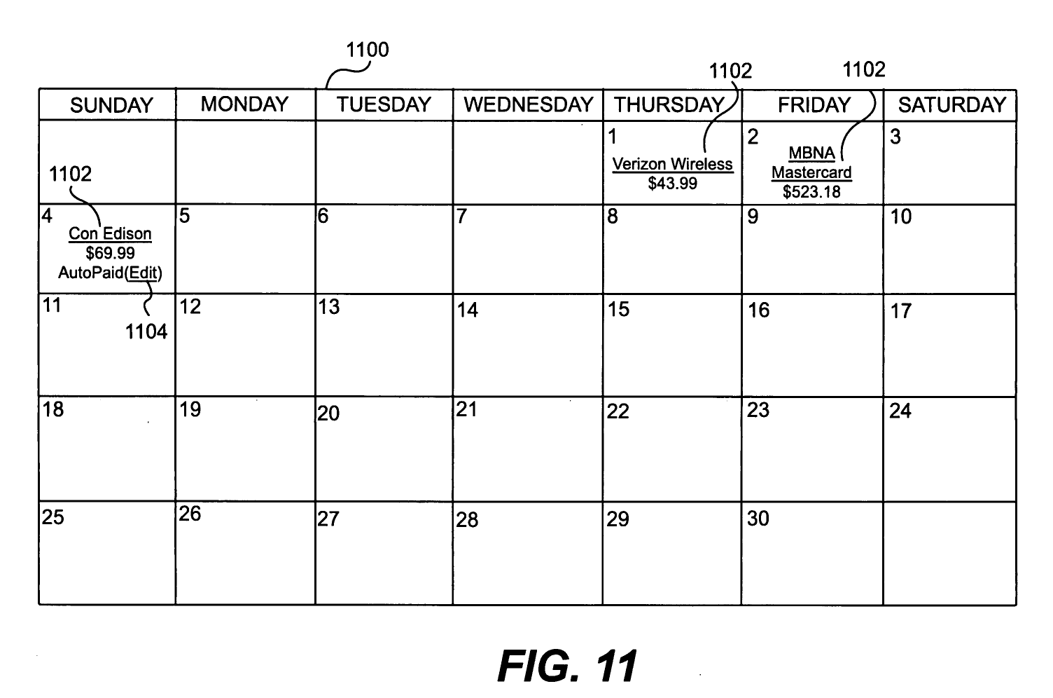

Complementary to outstanding bill list screen 1000 is an exemplary calendar screen 1100 (FIG. 11). In screen 1100, outstanding bill payments are displayed in the date spaces that correspond to their respective due dates. The user may access additional information about the bills by, for example, clinking on bill details 1102. Auto-payments associated with certain bills may be edited, for example, by clicking on the associated edit link 1104.

It will be understood that FIGS. 10 and 11 are merely illustrative of such display screens for presenting the consolidated account information at an access point such as a data-enabled phone or television, consistent with the principles of the present invention. Any other suitable formats or screens may be used without departing from the spirit of the present invention. Also, as described above in connection with account information of FIG. 9, the outstanding bill information and payment options of FIGS. 10 and 11 may additionally be provided to the user in voice format, for example, using voice recognition 412 or another suitable mechanism.

Also as mentioned above, the aggregated financial services may include balance transfer among the user's various accounts. Generally, balance transfers between accounts of different financial intuitions are complicated to perform in traditional systems because different financial institutions involved in the transfer must authenticate the user to an account at another financial institution. This process typically requires the user to provide extensive information about the accounts, including bank names, routing numbers, account numbers, addresses, phone numbers, etc. Providing balance transfer as an aggregated service minimizes the hassle of having to repeatedly provide the long list of account information for routing funds. As a part of the aggregated services, the user may be instantly verified and authenticated to the multiple accounts, for example, using the one credential authentication described above or any other suitable authentication methods. In this way, the user may choose to transfer funds among accounts at different financial institutions and be verified instantly as if the user were transferring funds among the accounts at a single institution.

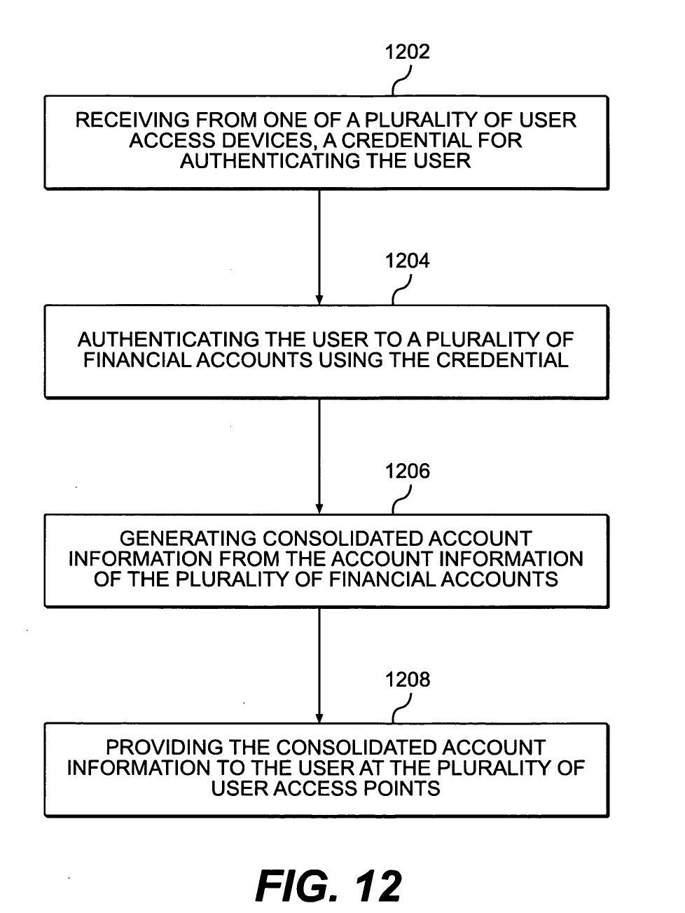

In summary, FIG. 12 shows a flow chart of illustrative steps involved in providing consolidated financial information to a user at the user's plurality of user access points. At step 1202, the user provides a credential for authentication from a user access point. As described above, the user access point may be any suitable portal that is capable of connecting to application service/business logic 504, enhanced television services system 1604, or any other suitable system or service for providing services such as aggregated financial services. User access point may be implemented on a phone, a television, a PDA, a laptop, a PVR, or any other suitable device that is consistent with the description of a phone 114, such as one consistent with user terminals 112_A and 112_B, a network terminal 1702, or any other suitable device. The user may also use a different device to transmit the credential each time the user logs in.

The received credential is then used to authenticate the user to a plurality of financial accounts that are associated with the user at step 1204. While each of the financial accounts may require different authentication credentials and/or authentication procedures, only a single received credential may be needed to authenticate the user to these accounts. The single sign-on may be achieved according to any suitable method, for example, according to a method as described above in connection with a SSO server.

Once the user is authenticated to the plurality of financial accounts, consolidated account information may be generated from the account information of the plurality of financial accounts at step 1206. As an example, the user's assets and liabilities in the various accounts may be combined to calculate total net worth, total liabilities, total banking amounts, total investment amounts, and any other suitable consolidated financial figures. As another example, similar account information, such as asset information, stock information, etc., may be organized by category across accounts and displayed together. As yet another example, alerts and reminders associated with the various accounts may be displayed to the user in a collective format, for example, in a list.

At step 1208, the consolidated account information generated at step 1204 may be provided to the user at the user's plurality of user access points. For example, screens such as those illustrated in FIGS. 6-9 may be shown to the user at any of the user's user access points that is capable of displaying such information, including a phone, a television, a PDA, etc. The content and display of these screens may be automatically or manually adjusted to suit the display needs and limitations of a particular user access point. As an example, if the user access point chosen by the user is a television at a network terminal that is capable of displaying text and graphics, the consolidated account information may be structured so that a graphically enhanced version of each table in FIG. 9 may be displayed on the television. As another example, if the user access point chosen by the user is a phone having text messaging capabilities, the consolidated account information may be constructed as streaming messages, for example, in response to user selection. As yet another example, the consolidated account information may be translated or otherwise presented as voice messages, for example, when the user's user access point has voice capabilities.

It will be understood that FIG. 12 is merely illustrative of the steps involved in presenting consolidated financial account information to the user. Any other suitable steps may be added and any suitable modifications may be made to the illustrated steps without departing from the spirit of the present invention.

In another aspect of the present invention, aggregated financial services include alerting or notifying the user of account activities, transactions, and any other suitable account-related events at one or more of the user's user access points. The notification may be specific to each type of service, including bill payments, fund transfers, overdrafts, account activities, mileages, etc. For each type of service, the alert or notification may be specific as to the type of events, including, for example, cleared checks, completed payments, warning of overdrafts, completed transfers, and any other suitable events. In some embodiments of the present invention, the user may be alerted to or reminded of future events (or the future nature of the transaction or event) such as unpaid bills, scheduled transfers, and any other suitable future events. Similarly, the user may be alerted to a previous event.

The alerts may be generated automatically based on, for example, default notification criteria, or may be customized and requested by the user. When a notification is received by the user, the user has options such as closing the notification permanently, snoozing the notification, or taking an appropriate action in response to the notification. If the notification is snoozed, the user may be allowed to elect to receive the notification at a later time. In such a way, the notification may be redelivered to the user at a later time, which may be either customizable by the user or automatically determined.

In some embodiments of the present invention, the notification, as described above, may be sent to a preferred user access point, such as a phone or a television associated with a network terminal. The preferred user access point may be selected by the user or, in some embodiments, automatically selected by the notification server. As an example, the user may select the preferred user access point to receive notification by, for example, executing digital companion client software at a user access point to communicate with digital companion server 406, using a television interface to indicate such a preference to enhanced television services system 1604. As another example, the user may access a web page resident in digital companion server 406 to specify the preferred user access point, such as the user's cell phone. As yet another example, the user may place a call from, for example, phone 114, to a service number at voice portal 412, where the user may interact with automated voice response menus or speak to a service representative to specify a preferred user access point. Any other suitable user selection methods may also be used.

The identity of the preferred user access point may be stored, for example, in database 522 or subscriber database 1608. The user may repeat the above process to effect any changes. The user may also specify different preferred user access points for notification delivery within various time frames, such as days of the week or hours of the day.

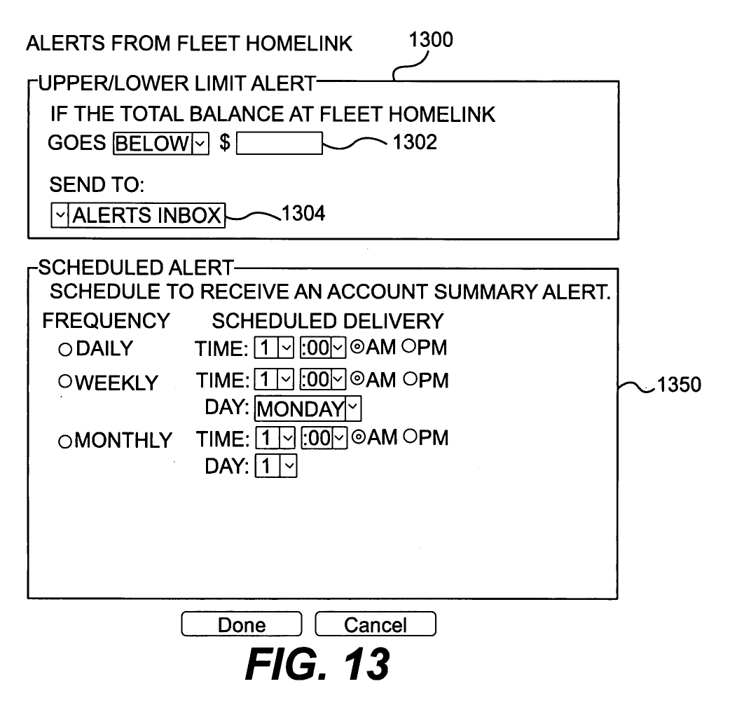

FIG. 13 shows an illustrative screen 1300 for allowing the user to schedule a notification when the balance in a bank account goes beyond a limit in accordance with one embodiment of the present invention. The user may provide a dollar limit 1302 at which a notification is to be generated. The user may also select, for example, using drop down menu 1304, a user access point to which the notification is to be sent. The user may default the user access point selection to automatic determination.

Another screen 1350 may be displayed either separately or in combination with screen 1300 in accordance with one embodiment of the present invention. In screen 1350, the user may schedule the delivery of the alert or notification setup in screen 1300 by, for example, selecting the frequency and time at which the alert or notification is to be delivered.

Screens 1300 and 1350 of FIG. 13 are merely illustrative of such display screens. Any other suitable display screens may be used in connection with any suitable access point, such as a phone or a television, without departing from the spirit of the present invention.

As mentioned above, in some embodiments of the present invention, selection of a preferred user access point for notification delivery may be automatic and may be based on a variety of selection criteria, including, for example, frequency of use, time of last use, preferred time of use, and any other suitable criteria. In one example, user access point usage information may be collected by, for example, a usage tracking application resident on application server 516 of digital companion 406. The usage information may include, for example, the user access point used, the time used, the duration, and any other suitable usage information. The usage information may be stored, for example, in database 522 or any other suitable storage.

In one embodiment of the present invention, when a notification, such as a notification for an outstanding bill payment, is to be sent to a user, application server 516 may determine the user access point to which the notification is to be delivered by querying database 522. As an example, application server 516 may identify the selected user access point, such as one selected in screen 1300, for delivery of the notification. As another example, application server 516 may determine, based on stored usage information, whether the user is currently logged on to application service/business logic plane 504 through a user access point. If user login is detected at a user access point, client proxy 512, for example, may send the notification to the user access point at which the user is active so the user may be immediately alerted to the outstanding bill payment. As yet another example, application server 516 may determine that a particular user access point is more frequently used, is last used, is used for long periods of time, or has another suitable usage characteristic that makes it the preferred user access point for receiving the notification. In response to such a determination, the notification may be stored in database 522 to be sent to the determined user access point when the user logs in. In some embodiments of the present invention, alerts and notifications may be delivered to multiple of the user's associated user access points. If an alert or notification is closed or turned off at one user access point, all other corresponding notifications may be deleted.

Depending on the preferred user access point selected, client proxy 512 may provide the notification to the user access point in a suitable format. For example, if the selected device has voice capabilities, such as phone 114, client proxy 512 may forward the notification to voice portal 412, which may translate the notification into a voice message before delivery to phone 114. The translation may be performed, for example, using voice recognition 416. Alternatively, if the selected user access point is implemented on a device that is capable of processing text and/or graphics, such as a television, a PDA, a laptop, a data-enabled cell phone, etc., client proxy 512 or enhanced television services system may send a text and/or graphic notification, for example, to be processed and delivered to the user access point by communications portal 408, or sent using any other suitable delivery or communication channel of such information.

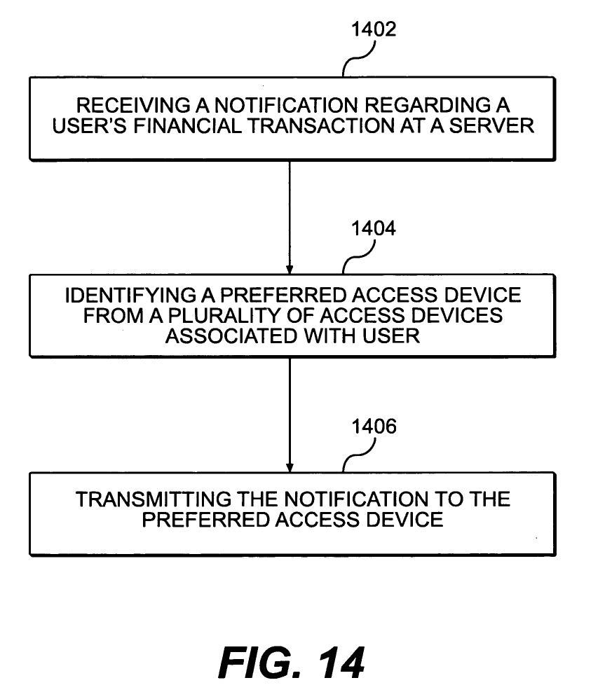

FIG. 14 is a flow chart of illustrative steps involved in delivering a notification regarding a financial transaction to a user's preferred user access point in accordance with one embodiment of the present invention. At step 1402, a notification, such a notification generated by web-based service 552 indicating, for example, a completed transaction, a future transaction, or any other suitable notification event, including, a bill payment due, a cleared check, or any other event that demands the user's attention, may be received by a server, such as application server 528, application server 516, or a service associated with enhanced television service system 1604.

In response to receiving such a notification, an application server may take actions to identify an appropriate user access point for delivering the notification to the user at step 1404. As described above, the application server may select the preferred user access point by, for example, querying database 522 or subscriber database 1608. Suitable information stored in database 522 or subscriber database 1608 such as a preferred user access point, device usage information, etc., may be utilized to make the user access point selection.

Once the preferred user access point for receiving the notification is determined, the notification may be transmitted to the selected user access point in a suitable format at step 1406. The suitable format, as described above, may be determined based on the limitations of the user access point to which the notification will be delivery as well as the characteristics of the notification. Also as mentioned above, additional conditions, such as whether the user is currently logged in at the selected user access point may be considered, for example, to determine the timing of the transmission.

It will be understood that FIG. 14 is merely illustrative of a notification delivery process in accordance with an embodiment of the present invention. Any other suitable steps may be taken without exceeding the scope of the present invention.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

What is claimed is:

1. A method for providing aggregated financial information to a user at a plurality of user access points, the method comprising:
receiving from one of the plurality of user access points, a credential for authenticating the user;
authenticating the user to a plurality of financial accounts using the received credential, wherein at least two of the plurality of financial accounts are maintained by different financial institutions;
generating consolidated account information from account information associated with the plurality of financial accounts; and
providing the consolidated account information to the user at the plurality of user access points.

2. The method of claim 1, wherein the plurality of financial accounts include at least two categories of accounts selected from bank accounts, brokerage accounts, credit card accounts, and mortgage accounts.

3. The method of claim 1, further comprising allowing the user to perform a financial transaction using one or more of the plurality of financial accounts.

4. The method of claim 3, wherein allowing the user to perform the financial transaction comprises allowing the user to perform a balance transfer between two of the financial accounts.

5. The method of claim 3, wherein allowing the user to perform the financial transaction comprises allowing the user to make a bill payment.

6. The method of claim 1, wherein providing the consolidated account information to the user at the plurality of user access points comprises providing the consolidated account information as a voice message at one of the plurality of user access points.

7. The method of claim 1, further comprising allowing the user to customize a presentation of the consolidated account information on the plurality of user access points.

8. The method of claim 1, further comprising automatically adjusting a presentation of the consolidated account information into a suitable format for display on each of the plurality of user access points.

9. A method for providing a notification regarding a financial transaction to a preferred user access point, the method comprising:
receiving the notification regarding a user's financial transaction at a server;
identifying the preferred user access point from a plurality of user access points associated with the user, wherein each of the plurality of user access points has a communication channel capable of receiving the notification; and
transmitting the notification to the preferred user access point.

10. The method of claim 9, further comprising allowing the user to perform a related financial transaction in response to receiving the notification at the preferred user access point.

11. The method of claim 9, further comprising allowing the user to elect to receive the notification at a later time and providing the notification to the user at the later time.

12. The method of claim 9, wherein the notification relates to a completion of the user's financial transaction.

13. The method of claim 9, wherein the notification relates to a pending nature of the user's financial transaction.

14. The method of claim 9, wherein the notification relates to a future nature of the user's financial transaction.

15. The method of claim 9, wherein identifying the preferred user access point comprises tracking usage information associated with the plurality of user access points and identifying the preferred user access point based on one or more characteristics of the usage information.

16. The method of claim 9, further comprising allowing the user to schedule the transmission of the notification to the preferred user access point.

17. A system for providing aggregated financial information, the system comprising:
a plurality of user access points implemented on a plurality of access devices;
a server configured to:
receive from one of the plurality of user access points, a credential for authenticating the user;
authenticate the user to a plurality of financial accounts using the received credential, wherein at least two of the plurality of financial accounts are maintained by different financial institutions;
generate consolidated account information from account information associated with the plurality of financial accounts; and
provide the consolidated account information to the user at the plurality of user access points.

18. The system of claim 17, wherein the plurality of financial accounts include at least two categories of accounts selected from bank accounts, brokerage accounts, credit card accounts, and mortgage accounts.

19. The system of claim 17, wherein the server is further configured to allow the user to perform a financial transaction using one or more of the plurality of financial accounts.

20. The system of claim 19, wherein the server is further configured to allow the user to perform a balance transfer between two of the financial accounts.

21. The system of claim 19, wherein the server is further configured to allow the user to perform the financial transaction comprises allowing the user to make a bill payment.

22. The system of claim 17, wherein the server is further configured to provide the consolidated account information as a voice message at one of the plurality of user access points.

23. The system of claim 17, wherein the server is further configured to allow the user to customize a presentation of the consolidated account information on the plurality of user access points.

24. The system of claim 17, wherein the server is further configured to automatically adjust a presentation of the consolidated account information into a suitable format for display on each of the plurality of user access points.

25. A system for providing a notification regarding a financial transaction to a preferred user access point, the system comprising:
a plurality of user access points implemented on a plurality of access devices, wherein each of the plurality of user access points has a communication channel capable of receiving the notification;
a server configured to:
receive the notification regarding a user's financial transaction;
identify the preferred user access point from a plurality of user access points associated with the user; and
transmit the notification to the preferred user access point.

26. The system of claim 25, wherein the server is further configured to allow the user to perform a related financial transaction in response to receiving the notification at the preferred user access point.

27. The system of claim 25, wherein the server is further configured to allow the user to elect to receive the notification at a later time and providing the notification to the user at the later time.

28. The system of claim 25, wherein the notification relates to a completion of the user's financial transaction.

29. The system of claim 25, wherein the notification relates to a pending nature of the user's financial transaction.

30. The system of claim 25, wherein the notification relates to a future nature of the user's financial transaction.

31. The system of claim 25, wherein the server is further configured to track usage information associated with the plurality of user access points and identify the preferred user access point based on one or more characteristics of the usage information.

32. The system of claim 25, wherein the server is further configured to allow the user to schedule the transmission of the notification to the preferred user access point.

33. A computer-readable medium including instructions for performing, when executed by a processor, a method for providing aggregated financial information to a user at a plurality of user access points, the method comprising:
receiving from one of the plurality of user access points, a credential for authenticating the user;
authenticating the user to a plurality of financial accounts using the received credential, wherein at least two of the plurality of financial accounts are maintained by different financial institutions;
generating consolidated account information from account information associated with the plurality of financial accounts; and
providing the consolidated account information to the user at the plurality of user access points.

34. The computer-readable medium of claim 33, wherein the plurality of financial accounts include at least two categories of accounts selected from bank accounts, brokerage accounts, credit card accounts, and mortgage accounts.

35. The computer-readable medium of claim 33 further includes instructions for allowing the user to perform a financial transaction using one or more of the plurality of financial accounts.

36. The computer-readable medium of claim 35 further includes instructions for allowing the user to perform a balance transfer between two of the financial accounts.

37. The computer-readable medium of claim 35 further includes instructions for allowing the user to make a bill payment.

38. The computer-readable medium of claim 33 further includes instructions for providing the consolidated account information as a voice message at one of the plurality of user access points.

39. The computer-readable medium of claim 33 further includes instructions for allowing the user to customize a presentation of the consolidated account information on the plurality of user access points.

40. The computer-readable medium of claim 33 further includes instructions for automatically adjusting a presentation of the consolidated account information into a suitable format for display on each of the plurality of user access points.

41. A computer-readable medium including instructions for performing, when executed by a processor, a method for providing a notification regarding a financial transaction to a preferred user access point, the method comprising:
receiving the notification regarding a user's financial transaction at a server;
identifying the preferred user access point from a plurality of user access points associated with the user, wherein each of the plurality of user access points has a communication channel capable of receiving the notification; and
transmitting the notification to the preferred user access point.

42. The computer-readable medium of claim 41 further includes instructions for allowing the user to perform a related financial transaction in response to receiving the notification at the preferred user access point.

43. The computer-readable medium of claim 41 further includes instructions for allowing the user to elect to receive the notification at a later time and providing the notification to the user at the later time.

44. The computer-readable medium of claim 41, wherein the notification relates to a completion of the user's financial transaction.

45. The computer-readable medium of claim 41, wherein the notification relates to a pending nature of the user's financial transaction.

46. The computer-readable medium of claim 41, wherein the notification relates to a future nature of the user's financial transaction.

47. The computer-readable medium of claim 41 further includes instructions for tracking usage information associated with the plurality of user access points and identifying the preferred user access point based on one or more characteristics of the usage information.

48. The computer-readable medium of claim 41 further includes instructions for allowing the user to schedule the transmission of the notification to the preferred user access point.

49. A method for providing aggregated financial information to a user at a network terminal, comprising:
receiving from a network terminal, a credential for authenticating the user, wherein the network terminal having an associated a television;
authenticating the user to a plurality of financial accounts using the received credential, wherein at least two of the plurality of financial accounts are maintained by different financial institutions;
generating consolidated account information from account information associated with the plurality of financial accounts; and
providing the consolidated account information to the user at the network terminal, wherein the consolidated account information is displayed on the television.

50. The method of claim 49, wherein the plurality of financial accounts include at least two categories of accounts selected from bank accounts, brokerage accounts, credit card accounts, and mortgage accounts.

51. The method of claim 49, further comprising allowing the user to perform a financial transaction, via an interface of the television, using one or more of the plurality of financial accounts.

52. The method of claim 51, wherein allowing the user to perform the financial transaction comprises allowing the user to perform a balance transfer between two of the financial accounts.

53. The method of claim 51, wherein allowing the user to perform the financial transaction comprises allowing the user to make a bill payment.

54. The method of claim 49, further comprising allowing the user to customize a presentation of the consolidated account information on the television interface.

55. The method of claim 49, further comprising automatically adjusting a presentation of the consolidated account information into a suitable format for display on the television interface.

56. A method for providing a notification regarding a financial transaction to a network terminal, the method comprising:
receiving the notification regarding a user's financial transaction at a server;
identifying the network terminal associated with the user, wherein the network terminal has an associated a television and has a communication channel capable of receiving the notification; and
transmitting the notification to the network terminal, wherein the notification is display at an interface of the television.

57. The method of claim 56, further comprising allowing the user to perform a related financial transaction in response to receiving the notification at the network terminal.

58. The method of claim 56, further comprising allowing the user to elect to receive the notification at a later time and providing the notification to the user at the later time.

59. The method of claim 56, wherein the notification relates to a completion of the user's financial transaction.

60. The method of claim 56, wherein the notification relates to a pending nature of the user's financial transaction.

61. The method of claim 56, wherein the notification relates to a future nature of the user's financial transaction.

62. The method of claim 56, further comprising allowing the user to schedule the transmission of the notification to the network terminal.

63. A system for providing aggregated financial information via a television network, the system comprising:
a network terminal, wherein the network terminal has an associated television;
a server configured to:
receive from the network terminal, a credential for authenticating the user;
authenticate the user to a plurality of financial accounts using the received credential, wherein at least two of the plurality of financial accounts are maintained by different financial institutions;
generate consolidated account information from account information associated with the plurality of financial accounts; and
provide the consolidated account information to the user at the network terminal, wherein the consolidated account information is display on an interface of the television.

64. The system of claim 63, wherein the plurality of financial accounts include at least two categories of accounts selected from bank accounts, brokerage accounts, credit card accounts, and mortgage accounts.

65. The system of claim 63, wherein the server is further configured to allow the user to perform a financial transaction using one or more of the plurality of financial accounts.

66. The system of claim 65, wherein the server is further configured to allow the user to perform a balance transfer between two of the financial accounts.

67. The system of claim 65, wherein the server is further configured to allow the user to perform the financial transaction comprises allowing the user to make a bill payment.

68. The system of claim 65, wherein the server is further configured to allow the user to customize a presentation of the consolidated account information on the interface of the television.

69. The system of claim 65, wherein the server is further configured to automatically adjust a presentation of the consolidated account information into a suitable format for display on the interface of the television.

70. A system for providing a notification regarding a financial transaction via a television network, the system comprising:
a network terminal, wherein the network terminal has an associated television and has a communication channel capable of receiving the notification;
a server configured to:
receive the notification regarding a user's financial transaction;
identify the network terminal associated with the user; and
transmit the notification to the network terminal, wherein the notification is displayed on an interface of the television.

71. The system of claim 70, wherein the server is further configured to allow the user to perform a related financial transaction in response to receiving the notification at the network terminal.

72. The system of claim 70, wherein the server is further configured to allow the user to elect to receive the notification at a later time and providing the notification to the user at the later time.

73. The system of claim 70, wherein the notification relates to a completion of the user's financial transaction.

74. The system of claim 70, wherein the notification relates to a pending nature of the user's financial transaction.

75. The system of claim 70, wherein the notification relates to a future nature of the user's financial transaction.

76. The system of claim 70, wherein the server is further configured to allow the user to schedule the transmission of the notification to the network terminal.
